(19) United States
(12) Patent Application Publication
(10) Pub. No.: US 2026/0318424 A1
(43) Pub. Date: Oct. 15, 2026

(54) DIAPHRAGM AND DIAPHRAGM VALVE INCLUDING SAME

(71) Applicant: ASAHI YUKIZAI CORPORATION, Nobeoka-shi, Miyazaki (JP)

(72) Inventor: Kota KUMAMOTO, Nobeoka-shi, Miyazaki (JP)

(21) Appl. No.: 19/483,239

(22) PCT Filed: May 10, 2024
(86) PCT No.: PCT/JP2024/017521

§ 371 Date: Nov. 11, 2025

(30) Foreign Application Priority Data
May 12, 2023 (JP) 2023-079722

(51) Int. Cl. F16K 7/12; C08J 3/28; F16K 1/34

(52) U.S. Cl. CPC F16K 7/12; C08J 3/28; F16K 1/34; C08J 2327/18; C08J 2329/10

(57) ABSTRACT

A diaphragm includes: a valve function part placed at the center thereof; a membrane part extending outward from the valve function part; and an outer peripheral edge part that is connected to an outer edge of the membrane part and is held between two members. Further, the diaphragm is formed from a resin material, and the membrane part has a membrane part non-crosslinked resin portion formed from a non-crosslinked resin material, and a membrane part crosslinked resin portion formed from a crosslinked resin material obtained by crosslinking a non-crosslinked resin material. The membrane part crosslinked resin portion constitutes a portion of the membrane part adjacent to the outer peripheral edge part, and the membrane part non-crosslinked resin portion constitutes a portion of the membrane part closer to the valve function part than the membrane part crosslinked resin portion.

### TECHNICAL FIELD

The present invention relates to a diaphragm in which a valve function part, such as a valve element part, is supported by a membrane part so as to be movable in the direction of a movement axis, and a diaphragm valve including the same.

### BACKGROUND ART

For example, when controlling a flow rate of a chemical solution used in a semiconductor manufacturing apparatus, there is often used a diaphragm valve that includes a diaphragm having a membrane part separating a valve chamber, through which chemical solution flows, from a drive unit, and a valve element part supported at the center of the membrane part. Generally, the diaphragm valve includes a valve body in which an inlet flow passage, an outlet flow passage, and a valve chamber communicating therewith are formed, a diaphragm disposed to close an upper opening of the valve chamber, and a drive unit attached to an upper portion of the valve body to drive the diaphragm. The valve body supports the diaphragm, and the drive unit reciprocates a valve element part, supported by the valve body via a membrane part of the diaphragm, along a movement axis, and brings the valve element part into contact with and away from a valve seat formed around an opening from the flow passage to the valve chamber, thereby performing opening and closing operations. Furthermore, for example, as in a diaphragm valve disclosed in PTL1, an outer peripheral edge part of the diaphragm valve, which is in contact with the valve body, is often pressed against and fixed to the valve body by the bottom part of the drive unit or via a diaphragm retainer configured as a separate member by the drive unit and is sandwiched directly or indirectly between the valve body and the drive unit, thereby preventing the outer peripheral edge part from being deformed during the reciprocating movement of the valve element part along the movement axis direction.

When the diaphragm valve is used in a line through which a chemical solution flows, the diaphragm is in contact with the chemical solution, and therefore, chemical resistance is required. Moreover, in the diaphragm valve, because the valve element part is moved in the movement axis direction to be brought into contact with and away from the valve seat, the membrane part supporting the valve element part is required to have flexibility and bending durability so that the membrane part can follow the movement of the valve element part. For this purpose, the diaphragm is generally formed of polytetrafluoroethylene (PTFE) that has flexibility and high bending durability, and the membrane part is made thin.

### CITATION LIST

### Patent Literature

PTL1: Japanese U.S. Pat. No. 6,681,723

### SUMMARY OF THE INVENTION

### Technical Problem

As described above, the outer peripheral edge part of the diaphragm valve sandwiched between the drive unit and the valve body is pressed against and fixed to the valve body by the bottom part of the drive unit or by the diaphragm retainer pressed toward the valve body by the drive unit. However, since the membrane part is thinned and easily deformable, the membrane part deforms following the contour of the bottom part of the drive unit or of the surface of the diaphragm retainer facing the valve chamber when the valve element part reciprocates along the direction of the movement axis. At this time, a connection portion of the membrane part with the outer peripheral edge part that contacts with the valve body slides against the valve body, and thus particles may be generated by abrasion due to friction. Because this contact region between the valve body and the membrane part near the outer peripheral edge part of the membrane part faces a fluid-contact region inside the valve chamber, particles may be mixed into the fluid flowing through the diaphragm valve if particles are generated. Because PTFE is easy to generate dust, this problem of particle generation near the outer peripheral edge part is more likely to occur especially when the diaphragm is formed of PTFE from the viewpoint of securing the flexibility of the membrane part and the excellent chemical resistance.

In the field where high cleanliness is required, particles generated within the diaphragm valve can be problematic. For example, in the manufacturing process of a semiconductor wafer, generated contaminants such as particles, various metals, and polymer compounds that remain or adhere to the semiconductor wafer can significantly affect product quality. Therefore, in the manufacturing process of the semiconductor wafer, the cleaning of semiconductor wafers is performed using cleaning liquids. However, when particles are generated in the diaphragm valve used in the manufacturing process of the semiconductor wafer, as described above, and cleaning liquid containing the generated particles is discharged from the diaphragm valve and is used for cleaning the semiconductor wafer, this causes a problem that sufficient cleaning cannot be performed and the cleanliness of the semiconductor wafer is decreased.

Accordingly, an object of the present invention is to solve the above-described problems existing in the prior art and to improve the wear resistance of the membrane part while maintaining the flexibility of the membrane part of the diaphragm, thereby suppressing particle generation from the diaphragm.

### Solution to Problems

In view of the above object, the present invention provides, as a first aspect thereof, a diaphragm including a valve function part provided at a center thereof, an annular membrane part extending outwardly from the valve function part and being deformable in a direction of a movement axis, and an outer peripheral edge part connected to an outer edge of the membrane part and sandwiched between two members, the valve function part being movably supported by the membrane part in the direction of the movement axis, in which the diaphragm is formed of a resin material, and the membrane part includes a membrane-part non-crosslinked resin portion formed of a non-crosslinked resin material and a membrane-part crosslinked resin portion formed of a crosslinked resin material obtained by crosslinking the non-crosslinked resin material, the membrane-part crosslinked resin portion constituting a portion of the membrane part adjacent to the outer peripheral edge, the membrane-part non-crosslinked resin portion constituting a portion of the membrane part on a side closer to the valve function part than the membrane-part crosslinked resin portion.

In the diaphragm, the portion of the membrane part adjacent to the outer peripheral edge part is constituted by the membrane-part crosslinked resin portion formed of the crosslinked resin material, and the portion of the membrane part on a side closer to the valve function part than the membrane-part crosslinked resin portion is constituted by the membrane-part non-crosslinked resin portion formed of the non-crosslinked resin material. Because the portion of the membrane part on the side closer to the valve function part than the membrane-part crosslinked resin portion is constituted by the membrane-part non-crosslinked resin portion, the membrane part can maintain sufficient flexibility to follow the movement of the valve function part along the direction of the movement axis if a resin material with excellent flexibility is selected as the non-crosslinked resin material forming the membrane-part non-crosslinked resin portion. Moreover, a crosslinked resin material exhibits higher density and improved wear resistance due to crosslinking, resulting in superior wear resistance compared to a non-crosslinked resin material. Since the portion of the membrane part adjacent to the outer peripheral edge part is constituted by the membrane-part crosslinked resin portion formed of the crosslinked resin material obtained by crosslinking the non-crosslinked resin material forming the membrane-part non-crosslinked resin portion, the portion of the membrane part adjacent to the outer peripheral edge part exhibits higher wear resistance than the portion of the membrane part on the side closer to the valve function part. Therefore, when the diaphragm is supported in a state where the outer peripheral edge part of the diaphragm is sandwiched between the two members, such as between the valve body (the component formed therein with the valve chamber) of the diaphragm valve and the drive unit for driving the diaphragm, even if the membrane part is deformed along with the reciprocating movement of the valve function part along the movement axis and the portion of the membrane part adjacent to the outer peripheral edge part comes into contact with the other member adjacent to the diaphragm, sliding wear of the membrane part is less likely to occur. As a result, particle generation is suppressed.

In the diaphragm, it is preferable that at least a portion of the outer peripheral edge part of the diaphragm is constituted by an outer-peripheral-edge crosslinked resin portion formed of the crosslinked resin material. Furthermore, it is more preferable that the outer peripheral edge part has a raised seal portion provided thereon for sealing between the two members, and the sealing portion is constituted by the outer-peripheral-edge crosslinked resin portion. With such a configuration, even if the outer peripheral edge part comes into contact with the other member when attaching the diaphragm, the outer peripheral edge part is less likely to wear and the particles generated during attachment can be prevented from being released into the fluid.

In one embodiment, the valve function part may be a valve element part. In this case, it is preferable that the valve element part has a bottom surface portion thereof constituted by a valve-function-part crosslinked resin portion formed of the crosslinked resin material. For example, when the valve function part is the valve element part that is brought into contact with and away from the valve seat, the wear resistance of the bottom surface portion of the valve element part is also improved, thereby making it possible to suppress particle generation from the bottom surface portion of the valve element part.

In the above-described diaphragm, it is more preferable that the membrane-part crosslinked resin portion is provided outside a maximum outer peripheral surface of the valve element part when viewed in the direction of the movement axis.

For example, the crosslinked resin material may be formed by irradiating the non-crosslinked resin material with radiation.

Further, the present invention provides, as a second aspect thereof, a diaphragm valve including: a valve body in which a first flow passage, a second flow passage, and a valve chamber communicating with the first and second flow passages are formed; the above-described diaphragm; and a force-applying mechanism for applying a force to the diaphragm, in which the valve function part is supported by the membrane part so as to be movable in the direction of the movement axis.

In one embodiment, the outer peripheral edge part may be sandwiched between the valve body and the force-applying mechanism. In this case, the outer peripheral edge part may be sandwiched between the force-applying mechanism and the valve body via a diaphragm retainer.

In another embodiment, the valve body may be configured by connecting a first valve body and a second valve body to each other, and the outer peripheral edge part of the diaphragm may be sandwiched between the first valve body and the second valve body.

In one embodiment, the valve function part may be a valve element part that is brought into contact with and away from an annular valve seat portion formed around an opening from the first flow passage to the valve chamber.

In another embodiment, the valve chamber may include a first valve chamber communicating with the first flow passage, a second valve chamber communicating with the second flow passage, and a communication passage communicating the first valve chamber and the second valve chamber with each other, and there is an annular valve seat portion formed around one end opening of the communication passage, the valve function part being a valve element part that is brought into contact with and away from the valve seat portion or a base part connected to the valve element part that is brought into contact with and away from the valve seat portion.

In either of the two embodiments described above, the crosslinked resin material forming the membrane-part crosslinked resin portion of the diaphragm may be crosslinked polytetrafluoroethylene or crosslinked perfluoroalkoxyalkane, and the non-crosslinked resin material forming the membrane-part non-crosslinked resin portion of the diaphragm may be non-crosslinked polytetrafluoroethylene or non-crosslinked perfluoroalkoxyalkane. In this case, it is preferable that the valve seat portion is constituted by a crosslinked resin portion formed of crosslinked polytetrafluoroethylene or crosslinked perfluoroalkoxyalkane, and it is more preferable that a remaining portion of the valve body other than the valve seat portion is constituted by a non-crosslinked resin portion formed of non-crosslinked polytetrafluoroethylene or non-crosslinked perfluoroalkoxyalkane.

The crosslinked resin material may be formed by irradiating the non-crosslinked resin material with radiation.

The diaphragm valve may further include an auxiliary diaphragm formed of a resin material, and the auxiliary diaphragm may include an auxiliary valve function part provided at a center thereof, an annular auxiliary membrane part extending outwardly from the auxiliary valve function part and being deformable in the direction of the movement axis, and an auxiliary outer peripheral edge part connected to an outer edge of the auxiliary membrane part and sandwiched between two members, the auxiliary valve function part being movably supported by the auxiliary membrane part in the direction of the movement axis and being connected to the valve function part of the diaphragm, the force-applying mechanism applying a force to the valve function part of the diaphragm via the auxiliary valve function part. In this case, it is preferable that the auxiliary membrane part includes an auxiliary-membrane-part non-crosslinked resin portion formed of the non-crosslinked resin material and an auxiliary-membrane-part crosslinked resin portion formed of the crosslinked resin material obtained by crosslinking the non-crosslinked resin material, the auxiliary-membrane-part crosslinked resin portion constituting a portion of the auxiliary membrane part adjacent to the auxiliary outer peripheral edge part, the auxiliary-membrane-part non-crosslinked resin portion constituting a portion of the auxiliary membrane part on a side closer to the auxiliary valve function part than the auxiliary-membrane-part crosslinked resin portion.

Alternatively, the diaphragm valve may further include an auxiliary diaphragm formed of a resin material and an auxiliary force-applying mechanism for applying a force to the auxiliary diaphragm, and the auxiliary diaphragm may include an auxiliary valve function part provided at a center thereof, an annular auxiliary membrane part extending outwardly from the auxiliary valve function part and being deformable in the direction of the movement axis, and an auxiliary outer peripheral edge part connected to an outer edge of the auxiliary membrane part and sandwiched between two members, the auxiliary valve function part being movably supported by the auxiliary membrane part in the direction of the movement axis and being applied with a force by the auxiliary force-applying mechanism. Furthermore, the auxiliary valve function part of the auxiliary diaphragm may be configured to be able to come into and out of contact with the valve function part of the diaphragm to apply a force to the valve function part. In this case, it is preferable that the auxiliary membrane part includes an auxiliary-membrane-part non-crosslinked resin portion formed of the non-crosslinked resin material and an auxiliary-membrane-part crosslinked resin portion formed of the crosslinked resin material obtained by crosslinking the non-crosslinked resin material, the auxiliary-membrane-part crosslinked resin portion constituting a portion of the auxiliary membrane part adjacent to the auxiliary outer peripheral edge part, the auxiliary-membrane-part non-crosslinked resin portion constituting a portion of the auxiliary membrane part on a side closer to the auxiliary valve function part than the auxiliary-membrane-part crosslinked resin portion.

### Advantageous Effects of the Invention

According to the present invention, because the portion of the membrane part on the side closer to the valve function part than the membrane-part crosslinked resin portion is constituted by the membrane-part non-crosslinked resin portion, the membrane part can maintain sufficient flexibility to follow the movement of the valve function part along the direction of the movement axis if a resin material with excellent flexibility is selected as the non-crosslinked resin material forming the membrane-part non-crosslinked resin portion. Moreover, since the portion of the membrane part adjacent to the outer peripheral edge part is constituted by the membrane-part crosslinked resin portion formed of the crosslinked resin material obtained by crosslinking the non-crosslinked resin material forming the membrane-part non-crosslinked resin portion, the portion of the membrane part adjacent to the outer peripheral edge part exhibits higher wear resistance than the portion of the membrane part on the side closer to the valve function part. Therefore, when the membrane part is deformed along with the reciprocating movement of the valve function part along the movement axis, even if the portion adjacent to the outer peripheral edge part comes into contact with the other member adjacent to the diaphragm, sliding wear of the membrane part is less likely to occur and thus particle generation is suppressed.

### BRIEF DESCRIPTION OF THE DRAWINGS

FIG. 1 is a vertical cross-sectional view of an on-off valve that is a diaphragm valve including a diaphragm according to a first embodiment of the present invention and shows a closed valve state.

FIG. 2 is a vertical cross-sectional view showing an open state of the diaphragm valve shown in FIG. 1.

FIG. 3 is an enlarged cross-sectional view of a main part of the diaphragm valve shown in FIG. 1, showing a state where a valve element is seated on a valve seat.

FIG. 4 is a vertical cross-sectional view of a diaphragm valve including a diaphragm according a variation of the first embodiment of the present invention.

FIG. 5 is an explanatory diagram for illustrating positions of portions that are formed of a crosslinked resin material in the diaphragm shown in FIG. 3.

FIG. 6 is an explanatory diagram for illustrating a position of a portion that is formed of the crosslinked resin material in a valve body shown in FIG. 3.

FIG. 7 is an explanatory diagram schematically showing one embodiment of a crosslinking method for crosslinking a required place of the diaphragm formed of a non-crosslinked resin material.

FIG. 8 is an explanatory diagram schematically showing, by hatching, portions of the diaphragm that are crosslinked according to the crosslinking method shown in FIG. 7.

FIG. 9 is an explanatory diagram showing another embodiment of a crosslinking method for crosslinking the required place of the diaphragm formed of the non-crosslinked resin material.

FIG. 10 is a vertical cross-sectional view of a needle valve that is a diaphragm valve including a diaphragm according to a second embodiment of the present invention.

FIG. 11 is a vertical cross-sectional view of a constant pressure valve that is a diaphragm valve including a diaphragm according to a third embodiment of the present invention.

FIG. 12 is a vertical cross-sectional view of a back pressure valve that is a diaphragm valve including a diaphragm according to a fourth embodiment of the present invention.

FIG. 13 is a vertical cross-sectional view of a suck-back valve that is a diaphragm valve including a diaphragm according to a fifth embodiment of the present invention.

FIG. 14 is a vertical cross-sectional view of a constant flow valve that is a diaphragm valve including a diaphragm according to a sixth embodiment of the present invention.

### DESCRIPTION OF EMBODIMENTS

Embodiments of a diaphragm valve including a diaphragm according to the present invention will be described below with reference to the accompanying drawings.

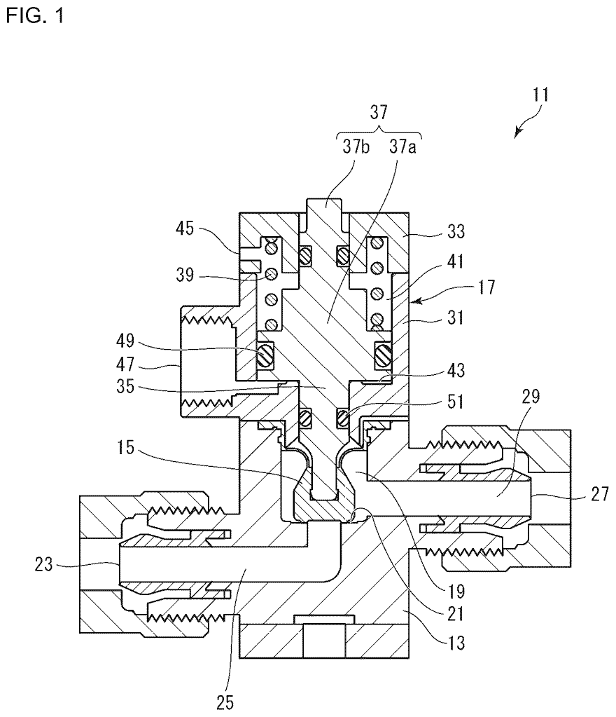

First, the overall configuration of a diaphragm valve 11 including a diaphragm according to a first embodiment will be described with reference to FIGS. 1 to 3. The diaphragm valve 11 is an on-off valve, and includes a valve body 13, a diaphragm 15, and a drive unit 17 that functions as a force-applying mechanism for applying a force to the diaphragm 15 and drives the diaphragm 15. The drive unit 17 is attached to an upper portion of the valve body 13.

The valve body 13 has a valve chamber 19 formed at an upper center thereof, and also has a first flow passage and a second flow passage that are formed therein and communicate with the valve chamber 19. The valve chamber 19 is formed, around an opening from the first flow passage into the valve chamber 19, with an annular valve seat 21 that the diaphragm 15 is brought into contact with and away from. In the shown embodiment, there is formed as the first flow passage an inlet flow passage 25 that extends from an inflow port 23 formed on one of opposite side surfaces of the valve body 13 and is opened to the bottom center of the valve chamber 19, and there is formed as the second flow passage an outlet flow passage 29 that extends from an outflow port 27 formed on the other of the opposite side surfaces of the valve body 13 and is opened to the side surface of the valve chamber 19. The annular valve seat 21 is formed around the opening from the inlet flow passage 25 into the valve chamber 19.

The drive unit 17 includes a drive unit housing 31 attached to the upper portion of the valve body 13 and having a mechanism accommodating space formed therein, a cover member 33 attached to an upper portion of the drive unit housing 31, a stem 35 coupled to the diaphragm 15, and a drive mechanism accommodated in the mechanism accommodating space and driving the stem 35. In the present embodiment, the drive unit housing 31 has a cylinder part formed therein as the mechanism accommodating space, and the drive mechanism is constituted by a piston 37 accommodated in the cylinder part and a coil spring 39 serving as a biasing member.

The piston 37 includes a piston body 37a slidably accommodated in the cylinder part of the drive unit housing 31 and a guide shaft 37b extending upward from the piston body 37a. The stem 35 is coupled to the piston body 37a so as to extend downward from the piston body 37a. The piston body 37a has an outer peripheral surface slidably contacting with an inner peripheral surface of the cylinder part in a vertical direction and partitions the internal space of the cylinder part into an upper space 41, surrounded by an upper surface of the piston body 37a, an inner peripheral wall of the cylinder part, and a ceiling surface (i.e., a lower surface of the cover member 33) of the cylinder part, and a lower space 43, surrounded by a lower surface of the piston body 37a, the inner peripheral wall of the cylinder part, and a bottom surface (i.e., a bottom part of the drive unit housing 31) of the cylinder part. The guide shaft 37b is slidably inserted into a through-hole penetrating through the cover member 33, thereby guiding the vertical movement of the piston 37. The stem 35 is slidably inserted into a through-hole penetrating through the bottom of the drive unit housing 31 and extends up to the valve chamber 19, with a tip thereof coupled to the diaphragm 15 (specifically, a valve function part 53 described below).

The cover member 33 is formed with a vent hole 45 that communicates with the portion of the cylinder part defining the upper space 41, so that ventilation can be performed between the upper space 41 and the outside through the ventilation hole 45. A working fluid supply port 47 that communicates with the bottom portion of the cylinder part partitioning the lower space 43 is formed on a side portion of the drive unit housing 31, so that a working fluid can be supplied into the lower space 43 through the working fluid supply port 47. Furthermore, the coil spring 39 is arranged in a compressed state between the lower surface of the cover member 33 (the ceiling surface of the cylinder part) and the upper surface of the piston body 37a.

Note that the drive unit 17 is attached to the valve body 13 so that the stem 35 and the guide shaft 37b of the piston 37 are oriented to be perpendicular to the valve seat 21. Moreover, O-rings 49 and 51 are respectively fitted on the outer peripheral surface of the piston body 37a and an outer peripheral surface of the stem 35 at the portion inserted through the through-hole of the bottom of the drive unit housing 31, thereby preventing leakage of the working fluid supplied to the lower space 43 from between the outer peripheral surface of the piston body 37a and the inner peripheral surface of the cylinder part of the drive unit housing 31 and between the outer peripheral surface of the stem 35 and the inner peripheral surface of the through-hole of the bottom of the drive unit housing 31 (i.e., the bottom surface of the cylinder part).

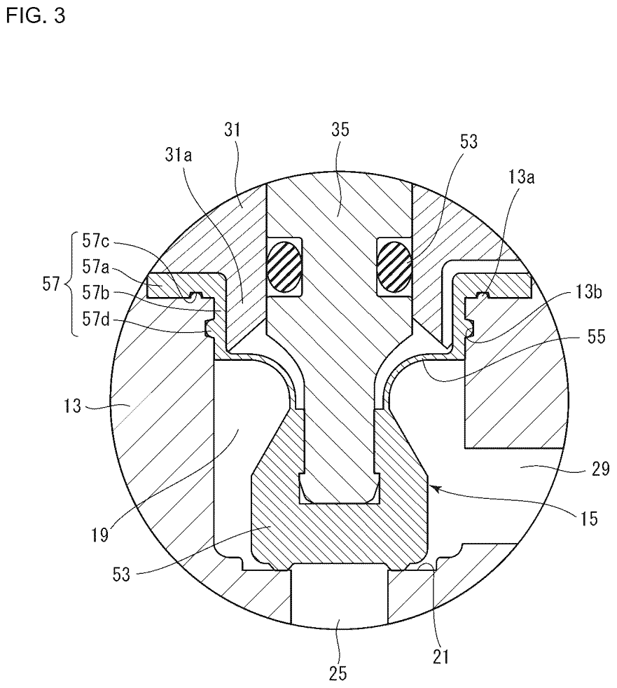

The diaphragm 15 is arranged so as to close the upper opening of the valve chamber 19, and is fixed to the valve body 13. As shown in detail in FIG. 3, the diaphragm 15 includes the valve function part 53 located at a center thereof, an annular membrane part 55 that is formed thinly to be easily bent and supports the valve function part 53 in the center, and an outer peripheral edge part 57 provided on an outer periphery of the membrane part 55. In the present embodiment, the valve function part 53 is constituted by a valve element part that is brought into contact with and away from the valve seat 21. The outer peripheral edge part 57 provided on the outer periphery of the membrane part 55 is sandwiched, at least in part, between an upper surface of a region surrounding an upper opening of the valve chamber 19 in the valve body 13 and the bottom surface of the drive unit housing 31, whereby the diaphragm 15 partitions the valve chamber 19 from the drive unit 17 in a state where the valve function part 53 is supported above the valve chamber 19 via the membrane part 55. In the shown embodiment, the valve element part that is the valve function part 53 has a shape like a circular truncated cone connected to a cylinder, namely, a spindle shape with a tapered upper end, and a bottom surface (valve seat contact surface) thereof is arranged so as to face the valve seat 21. However, the shape of the valve element part is not limited, as long as the valve element part can be supported inside the valve chamber 19 by the membrane part 55 and can be brought into contact with and away from the valve seat 21 to open and close the opening from the inlet flow passage 25 to the valve chamber 19. Moreover, the membrane part 55 is formed to extend radially outward from the outer periphery of the upper end of the valve function part 53, and the outer periphery of the membrane part 55 has a substantially circular shape.

In the present application, the term “outer peripheral edge part 57” of the diaphragm 15 refers to a portion that is sandwiched between two members, regardless of whether one of the sandwiching members is configured by a single member or multiple members. In the present embodiment, the outer peripheral edge part 57 is sandwiched between the valve body 13 and the drive unit 17 (specifically, the drive unit housing 31 thereof) that functions as the force-applying mechanism.

As shown in detail in FIG. 3, the outer peripheral edge part 57 includes an annular horizontal support portion 57a located at an outermost edge portion of the diaphragm 15 and extending in a horizontal direction, and a cylindrical vertical support portion 57b extending in the up-down direction (in the vertical direction) so as to connect an inner peripheral edge of the horizontal support portion 57a and an outer peripheral edge of the membrane part 55. The diaphragm 15 is fixed to the valve body 13 by inserting a protruding portion 31a, extending from the bottom center of the drive unit housing 31, into the upper opening of the valve chamber 19 of the valve body 13, thereby sandwiching the horizontal support portion 57a between the bottom surface of the drive unit housing 31 located outside the protrusion 31a and the upper surface of the region surrounding the upper opening of the valve chamber 19 in the valve body 13 and sandwiching the vertical support portion 57b between the outer peripheral surface of the protrusion 31a of the drive unit housing 31 and the inner peripheral surface of the upper opening of the valve chamber 19 in the valve body 13. Moreover, an annular groove 57c having a trapezoidal cross-section is provided on a bottom surface of the horizontal support portion 57a, and an annular protrusion 57d having a semicircular cross-section is provided on an outer surface of the vertical support portion 57b. Meanwhile, an annular protrusion 13a having a semicircular cross-section is provided on the upper surface of the region surrounding the upper opening of the valve chamber 19 in the valve body 13, and an annular groove 13b having a trapezoidal cross-section is provided on the inner peripheral surface of the upper opening of the valve chamber 19 of the valve body 13. The annular protrusions 13a and 57d are formed slightly larger than the corresponding annular grooves 57c and 13b, respectively, so that, when the protrusion 31a of the drive unit housing 31 is inserted into the valve chamber 19 of the valve body 13 to attach the drive unit housing 31 to the upper portion of the valve body 13 in a state where the annular protrusion 13a on the upper surface of the valve body 13 is engaged with the annular groove 57c of the horizontal support portion 57a and the annular protrusion 57d on the outer surface of the vertical support portion 57b is engaged with the annular groove 13b on the inner peripheral surface of the valve chamber 19, the annular protrusions 13a and 57d are deformed to tightly fit into the annular grooves 57c and 13b, thereby enhancing the sealing performance between the diaphragm 15 and the valve body 13.

In the present embodiment, as described above, the annular groove 57c is provided on the horizontal support portion 57a of the outer peripheral edge 57 of the diaphragm 15, and the annular protrusion 57d is provided on the vertical support portion 57b of the outer peripheral edge 57 of the diaphragm 15. The annular groove 57c and the annular protrusion 57d are respectively engaged with the annular protrusion 13a provided on the inner peripheral surface of the upper opening of the valve body 13 and the annular groove 13b provided on the inner peripheral surface of the valve chamber 19. However, alternatively, the diaphragm 15 may be configured such that an annular protrusion is provided on the horizontal support portion 57a of the diaphragm 15 and an annular groove is provided on the vertical support portion 57b of the diaphragm 15, and the provided annular protrusion and annular groove may be respectively engaged with an annular groove provided on the inner peripheral surface of the upper opening of the valve body 13 and an annular protrusion provided on the inner peripheral surface of the valve chamber 19. Moreover, both of the horizontal support portion 57a and the vertical support portion 57b may each be provided with an annular protrusion or groove, or only one of the horizontal support portion 57a and the vertical support portion 57b may be provided with either an annular groove or an annular protrusion.

Because the diaphragm 15, particularly the membrane part 55, is subjected to repeated bending, it is preferable that the diaphragm 15 is formed of polytetrafluoroethylene (PTFE) having flexibility and high flex resistance. On the other hand, because the valve function part 53 serving as the valve element part tends to generate particles upon contact with the valve seat 21, it is preferable that the valve function part 53 is formed of perfluoroalkoxyalkane (PFA), which has low particle generation characteristics. Therefore, the diaphragm 15 may be formed such that only the bottom surface portion (valve seat contact surface) of the valve function part 53 (i.e., the valve element part) is made of PFA while the remaining portions of the diaphragm 15 are made of PTFE, thereby using the different materials for the bottom surface of the valve element part (the valve function part 53) of the diaphragm 15 and the other portions. The valve body 13, the drive unit housing 31 of the drive unit 17, the cover member 33, the stem 35, and the piston 37 can each be formed of appropriate materials such as polyvinylidene fluoride (PVDF), PTFE, PFA, or polychlorotrifluoroethylene (PCTFE).

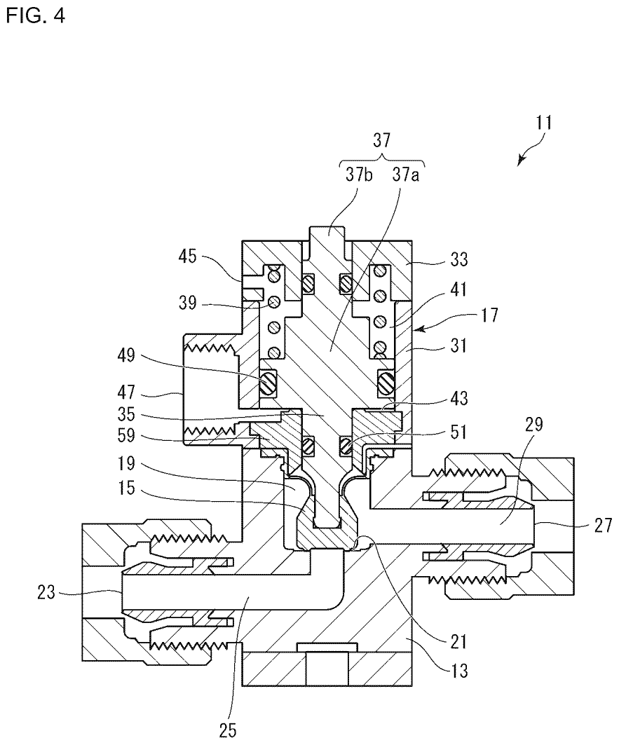

In the embodiment shown in FIGS. 1 to 3, the diaphragm 15 is fixed to and supported by the valve body 13 by directly sandwiching the outer peripheral edge part 57 between the region surrounding the upper opening of the valve chamber 19 in the valve body 13 and the bottom of the drive unit housing 31 that serves as the force-applying mechanism. However, the outer peripheral edge part 57 of the diaphragm 15 is not required to be directly sandwiched between the valve body 13 and the drive unit housing 31, and may alternatively be indirectly sandwiched between the valve body 13 and the drive unit housing 31 via another member. For example, as in another embodiment shown in FIG. 4, the outer peripheral edge part may be indirectly sandwiched via a diaphragm retainer 59 between the valve body 13 and the drive unit housing 31 of the drive unit 17, which serves as the force-applying mechanism.

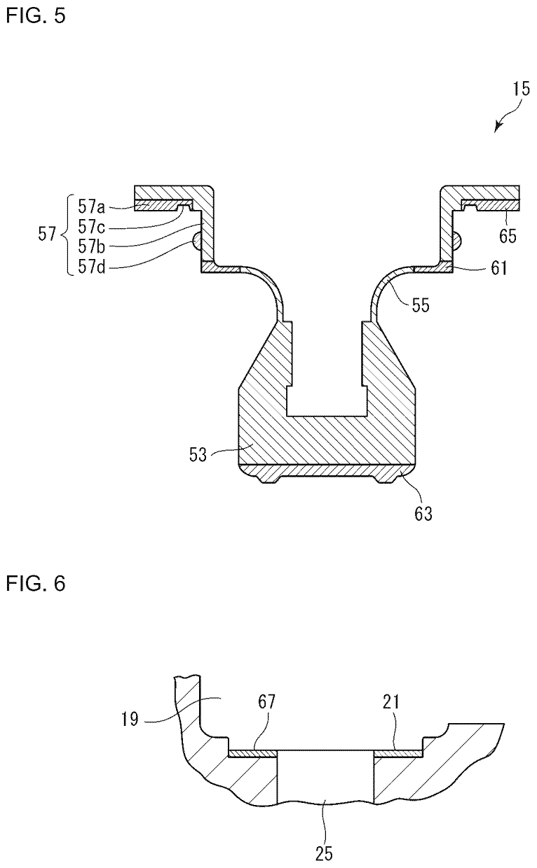

Furthermore, as shown in FIG. 5, in the diaphragm 15, while most portions thereof are formed of a non-crosslinked resin material such as PTFE or PFA described above, a connection portion 61 between the membrane part 55 and the outer peripheral edge part 57 is formed of a crosslinked resin material, and the membrane part 55 includes a membrane-part non-crosslinked resin portion formed of the non-crosslinked resin material and a membrane-part crosslinked resin portion formed of the crosslinked resin material. The membrane-part crosslinked resin portion of the membrane part 55 constitutes a portion adjacent to the outer peripheral edge part 57, while the membrane-part non-crosslinked resin portion of the membrane part 55 constitutes a portion closer to the valve function part 53 than the membrane-part crosslinked resin portion. Furthermore, it is preferable that the annular protrusion 57d provided on the vertical support portion 57b of the outer peripheral edge part 57, a bottom surface portion 63 of the valve function part 53 (i.e., the valve element part) that comes into contact with the valve seat 21, and a groove portion 65 of the horizontal support portion 57a of the outer peripheral edge part 57 where the annular groove 57c is provided are each constituted by a crosslinked resin portion formed of the crosslinked resin material. In other words, it is preferable that the annular protrusion 57d, the bottom surface portion 63 of the valve function part 53, and the groove portion 65 are constituted by an outer-peripheral-edge-part crosslinked resin portion formed of the crosslinked resin material, and the bottom surface portion 63 of the valve function part 53 is constituted by a valve-function-part crosslinked resin portion formed of the crosslinked resin material. Moreover, as shown in FIG. 6, a portion of the valve body 13 that constitutes the valve seat 21 (hereinafter, referred to as a valve seat portion 67), which comes into contact with the valve function part 53 serving as the valve element part, may also be constituted by a valve-seat-portion crosslinked resin portion formed of the crosslinked resin material. It is preferable that the crosslinked resin material is obtained by crosslinking the same non-crosslinked resin material used for forming other parts of the diaphragm 15 and the valve body 13.

In order to allow the valve function part 53, serving as the valve element part, to reciprocate relative to the valve seat 21 along the movement axis, the membrane part 55 of the diaphragm 15 is thinned to increase flexibility or pliability. In this way, the membrane part 55 is thinned and thus is easily deformable. Therefore, when the membrane part 55 is deformed along with the reciprocating movement of the valve function part 53 along the movement axis for the sake of opening and closing the diaphragm valve 11, a connection portion of the membrane part 55 with the outer peripheral edge part 57, namely, a portion of the membrane part 55 adjacent to the outer peripheral edge part 57 is also deformed following the contour of the protrusion 31a of the drive unit housing 31 or the diaphragm retainer 59 that sandwiches the outer peripheral edge part 57 with the valve body 13. At this time, the connection portion 61 of the membrane part 55 with the outer peripheral edge part 57 may slide against the valve body 13 to potentially generate particles due to abrasion by friction. Since a contact region of the membrane part 55 between the membrane part 55 and the valve body 13, adjacent to the outer peripheral edge part 57, faces a fluid-contact region within the valve chamber 19, any generated particles may be mixed into the fluid flowing through the diaphragm valve 11.

However, in the diaphragm 15, the connection portion 61 of the membrane part 55 with the outer peripheral edge part 57 (i.e., the portion adjacent to the outer peripheral edge part 57) is constituted by the membrane-part crosslinked resin portion. The crosslinked resin material forming the membrane-part crosslinked resin portion has increased density due to crosslinking and has higher wear resistance than the non-crosslinked resin material. Accordingly, even if the membrane part 55 is deformed during the reciprocating movement of the valve function part 53 along the movement axis for the sake of opening and closing the diaphragm valve 11 and the connection portion 61 of the membrane part 55 with the outer peripheral edge part 57 slides against the outer peripheral surface of the upper opening of the valve body 13, particle generation due to abrasion can be suppressed. Because PTFE tends to generate particles easily, it is more likely to generate particles particularly when the diaphragm 15 is formed of PTFE to secure flexibility and bending durability of the membrane part 55 of the diaphragm 15. Therefore, when the diaphragm 15 is formed of PTFE, the effects of suppressing particle generation become especially valid if the connection portion 61 of the membrane part 55 with the outer peripheral edge part 57 is formed of crosslinked PTFE.

When the annular groove 57c is provided on the horizontal support portion 57a and the annular protrusion 57d is provided on the vertical support portion 57b of the outer peripheral edge part 57 of the diaphragm 15, in order to enhance sealing performance as described above, the annular protrusion 13a of the valve body 13 is engaged with the annular groove 57c of the horizontal support portion 57a and the annular protrusion 57d of the vertical support portion 57b is engaged with the annular groove 13b of the valve chamber 19, thereby forming the annular protrusions 13a and 57d within the annular grooves 57c and 13b, respectively, to be tightly fitted therein by the pressing caused by the attachment of the drive unit housing 31 to the valve body 13. At this time, along with the deformation of the annular protrusions 13a and 57d, sliding may occur between the annular protrusions 13a and 57d and the annular grooves 57c and 13b, potentially generating particles due to the abrasion by sliding. Because the surfaces of the valve body 13 facing the horizontal support portion 57a and the vertical support portion 57b of the diaphragm 15 are connected to the fluid-contact region, any generated particles may be mixed into the fluid flowing through the diaphragm valve 11. However, if the annular protrusion 57d and the groove portion 65 are constituted by outer-peripheral-edge-part crosslinked resin portion formed of the crosslinked resin material, the generation of particles can be suppressed.

Furthermore, when the valve function part 53 of the diaphragm 15 is the valve element part as in the present embodiment, the valve function part 53 repeatedly moves along the movement axis to be brought into contact with and away from the valve seat 21 at the time of the opening and closing of the diaphragm valve 11. This may cause impacts that generate particles. However, if the bottom surface portion 63 of the valve element part serving as the valve function part 53 and the valve seat portion 67 are constituted by the valve-seat-portion crosslinked resin portion and the valve-function-part crosslinked resin portion formed of the crosslinked resin material, respectively, the generation of particles can likewise be suppressed.

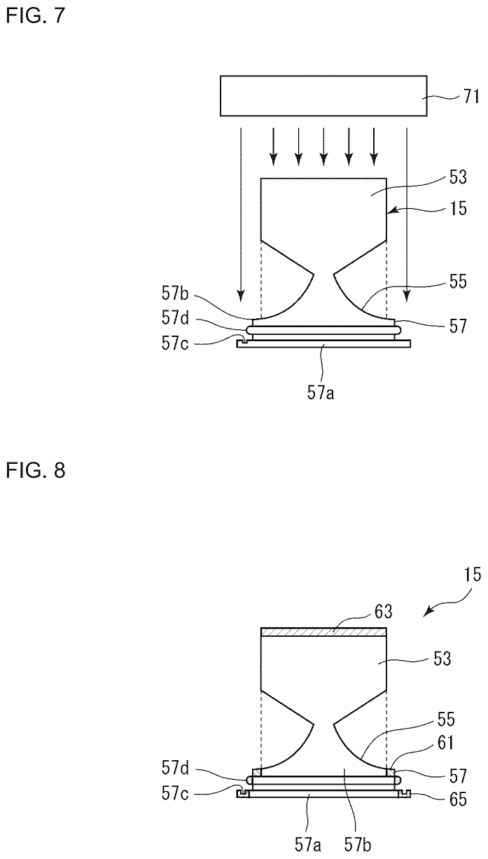

Next, a method of forming a crosslinked resin portion by crosslinking the non-crosslinked resin material in the diaphragm 15 formed of the non-crosslinked resin material will be described with reference to FIGS. 7 to 9.

First, the non-crosslinked resin material such as PTFE is processed in the shape of the diaphragm 15 by molding and cutting. Then, as shown in FIG. 7, while the diaphragm 15 is in a heated state, radiation is irradiated from a radiation source 71 disposed on the side of the valve function part 53 toward the diaphragm 15 formed of only the non-crosslinked resin material, thereby crosslinking the non-crosslinked resin material to form crosslinked resin portions. When the diaphragm 15 is viewed along the movement axis direction from the side of the radiation source 71, the bottom surface of the valve function part 53 and a portion located outside the maximum outer peripheral surface (i.e., the outer peripheral surface of a portion having the maximum outer diameter, or a surface to which a broken line extends in FIG. 7) of the valve function part 53 are exposed to a radiation. Accordingly, the bottom surface of the valve function part 53 and the portion located outside the maximum outer peripheral surface of the valve function part 53 are crosslinked and thereby constituted by the valve-function-part crosslinked resin portion formed of the crosslinked resin material. As shown in FIG. 7, when the diaphragm 15 is viewed along the movement axis direction from the side of the radiation source 71, if a portion of the membrane part 55 adjacent to the outer peripheral edge part 57 is provided outside the maximum outer peripheral surface of the valve function part 53 and the annular groove 57c is provided radially outward from the annular protrusion 57d, the bottom surface portion 63 of the valve function part 53, the connection portion 61 of the membrane part 55 with the outer peripheral edge part 57, the annular protrusion 57d, and the groove portion 65 of the horizontal support portion 57a are all exposed to a radiation, as shown in FIG. 8, thereby crosslinking non-crosslinked resin materials of these portions. As a result, the bottom surface portion 63 of the valve function part 53, the connection portion 61, the annular protrusion 57d, and the groove portion 65 are formed as crosslinked resin portions formed of the crosslinked resin material. Specifically, the bottom surface portion 63 of the valve function part 53 is constituted by the valve-function-part crosslinked resin portion, the connection portion 61 is constituted by the membrane-part crosslinked resin portion, and the annular protrusion 57d and the groove portion 65 are constituted by the outer-peripheral-edge-part crosslinked resin portion.

When the valve seat portion 67 of the valve body 13 is constituted by the valve-seat-portion crosslinked resin portion, the valve body 13 may be manufactured by molding and cutting from the non-crosslinked resin material such as PFA, and then, while in a heated state, a radiation from the radiation source 71 may be irradiated only to a portion forming the valve seat 21 (i.e., the valve seat portion 67), thereby crosslinking the non-crosslinked resin material of the portion forming the valve seat 21. Consequently, the valve seat portion 67 is constituted by the valve-seat-portion crosslinked resin portion formed of the crosslinked resin material.

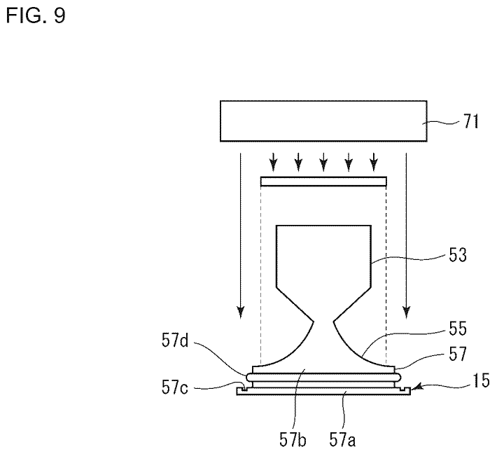

If it is desired that the bottom surface portion 63 of the valve function part 53 is constituted by a non-crosslinked resin portion instead of a crosslinked resin portion, masking may be applied, for example, to cover the bottom surface of the valve function part 53, as shown in FIG. 9, so that the radiation is not irradiated onto the bottom surface of the valve function part 53. In this case, if it is desired to form one or more of the connection portion 61, the annular protrusion 57d, and the groove portion 65 from the crosslinked resin material, the masking may not be applied to a portion to be formed of the crosslinked resin material when the diaphragm 15 is viewed along the direction of the movement axis from the side of the radiation source 71.

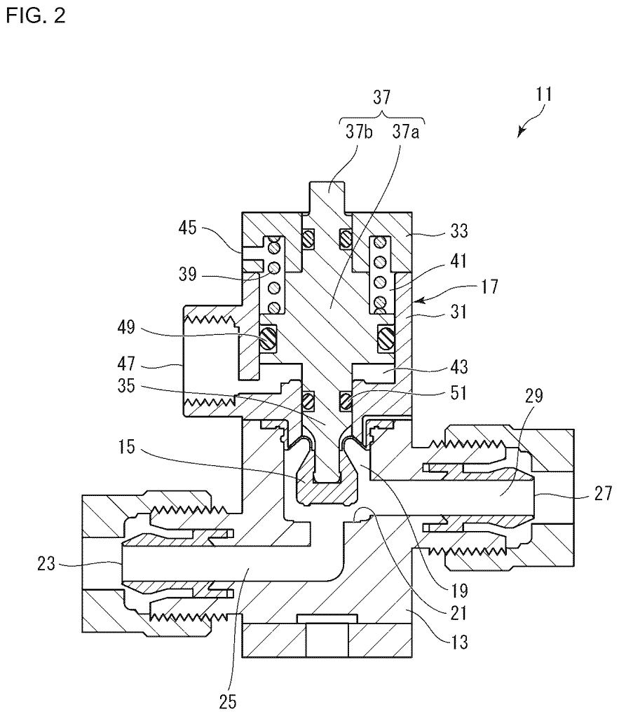

Next, operations of the diaphragm valve 11 will be described with reference to FIGS. 1 and 2. As shown in FIG. 1, in a normal state where no working fluid is supplied to the drive unit 17 from the working fluid supply port 47, the piston 37 of the drive unit 17 is biased downward and pushed down by the coil spring 39. As a result, the valve function part 53 of the diaphragm 15, which serves as the valve element part, is moved in a direction of approaching the valve seat 21 via the stem 35 and pressed against the valve seat 21, thereby bringing the diaphragm valve 11 into the closed state, as shown in FIG. 1. Along with this, the membrane part 55 supporting the valve function part 53 is also deformed in a direction away from the drive unit 17.

When working fluid is supplied to the working fluid supply port 47 of the drive unit 17 from the valve-closed state, the fluid pressure of the working fluid flowing into the lower space 43 of the cylinder part acts upward on the piston body 37a, pushing the piston 37 upward against the biasing force of the coil spring 39. At this time, air in the upper space 41 is released to the outside through the vent hole 45. As a result, the valve function part 53 serving as the valve element part is moved via the stem 35 in a direction away from the valve seat 21, thereby bringing the diaphragm valve 11 into the open state. Along with this, the membrane part 55 is also deformed in a direction approaching the drive unit 17. When the supply of the working fluid to the working fluid supply port 47 is stopped, the piston 37 is again biased downward and pushed down by the coil spring 39, pressing the valve function part 53 serving as the valve element part against the valve seat 21, thereby closing the diaphragm valve again.

In the diaphragm valve 11, the valve function part 53 serving as the valve element part is repeatedly brought into contact with and away from the valve seat 21. Particularly when the valve function part 53 contacts the valve seat 21, it is prone to generating particles due to impact. However, since the crosslinked resin material has superior wear resistance compared with the non-crosslinked resin material forming the other portions, if the bottom surface portion 63 of the valve function part 53 is constituted by the valve-function-part crosslinked resin portion formed of the crosslinked resin material (obtained by crosslinking the non-crosslinked resin material forming the other portions of the valve function part 53), particle generation can be suppressed compared with a case where the entire valve function part 53 serving as the valve element part is formed of the non-crosslinked resin material. Moreover, during the opening and closing operation of the diaphragm valve 11, the membrane part 55 is deformed by the reciprocating movement of the valve function part 53 along the direction of the movement axis. Along with this, in the diaphragm 15 fixed so as to cover the upper opening of the valve body 13, the connection portion 61 of the membrane part 55 adjacent to the outer peripheral edge part 57 may slide against the inner peripheral surface of the upper opening of the valve body 13 and may cause wear due to friction to generate particles. However, because the crosslinked resin material has superior wear resistance to that of the non-crosslinked resin material forming the other portions, if the connection portion 61 of the membrane part 55 is composed of the membrane-part crosslinked resin portion formed of the crosslinked resin material (obtained by crosslinking the non-crosslinked resin material forming the membrane part 55), particle generation can be suppressed compared with a case where the entire membrane part 55 is formed of the non-crosslinked resin material. As a result, the fluid flowing through the diaphragm valve 11 can be prevented from being contaminated by the particles.

In the first embodiment, the diaphragm 15 according to the present invention and the diaphragm valve 11 including the diaphragm 15 have been described by using the diaphragm valve 11 functioning as an on-off valve as an example, but the diaphragm according to the present invention is not limited to application to the diaphragm valve having the configuration according to the first embodiment. For example, the diaphragm according to the present invention can be applied to other types of diaphragm valves in which the diaphragm is disposed to face a fluid-contact region, such as a needle valve having a flow rate regulating function, a suck-back valve having a suck-back function for preventing fluid dropping, a constant flow valve, and a constant pressure valve or a back pressure valve for regulating a pressure.

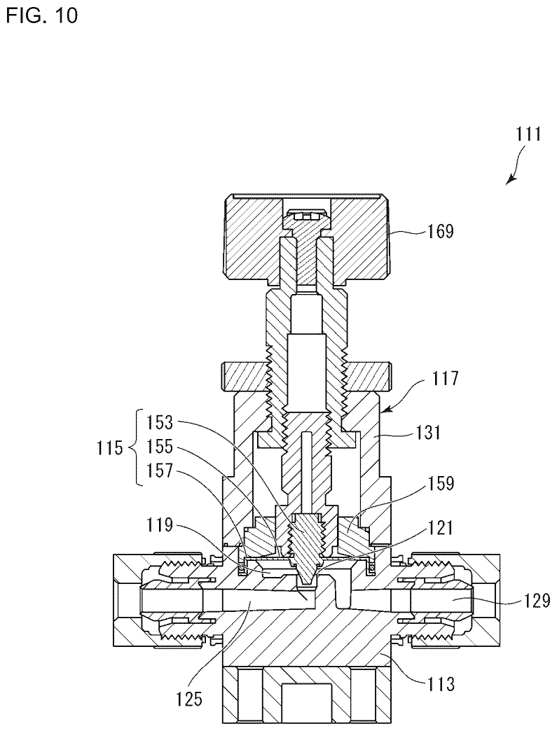

FIG. 10 shows a needle valve 111 that is a second embodiment of a diaphragm valve using a diaphragm 115 according to the present invention. The needle valve 111 includes a valve body 113, the diaphragm 115, and a drive unit 117 that drives the diaphragm 115, with the drive unit 117 attached to an upper portion of the valve body 113. The drive unit 117 functions as a force-applying mechanism that applies a force to the diaphragm 115. Similar to the diaphragm valve 11, the valve body 113 has a valve chamber 119 formed at the upper center thereof, and has an inlet flow passage 125 and an outlet flow passage 129 communicating with the valve chamber 119. The valve chamber 119 is formed, around an opening from the inlet flow passage 125 to the valve chamber 119, with an annular valve seat 121.

The diaphragm 115 is arranged so as to close the upper opening of the valve chamber 119, and is fixed to the valve body 113. The diaphragm 115 includes a needle 153 serving as a valve function part that approaches and separates from the valve seat 121, an annular membrane part 155 that supports the needle 153 so that the needle 153 can vertically move in the movement axis direction, and an outer peripheral edge part 157 provided on an outer periphery of the membrane part 155. In the embodiment shown in FIG. 10, the outer peripheral edge part 157 of the diaphragm 115 is indirectly sandwiched between the drive unit 117 (specifically, a drive unit housing 131 thereof) and the valve body 113 via a diaphragm retainer 159. However, the outer peripheral edge part 157 of the diaphragm 115 may alternatively be directly sandwiched between the drive unit 117 (specifically, the drive unit housing 131 thereof) and the valve body 113.

In the embodiment shown in FIG. 10, the drive unit 117 is configured to vertically move the needle 153 of the diaphragm 115 by rotating a handle 169 clockwise and counterclockwise, thereby enabling the needle 153 to approach and separate from the valve seat 121.

As described above, in the needle valve 111, the membrane part 155 is deformed along with the vertical movement of the needle 153, and a connection portion of the membrane part 155 with the outer peripheral edge part 157, namely, a portion adjacent to the outer peripheral edge part 157 is also deformed following the contour of the diaphragm retainer 159 that sandwiches the outer peripheral edge part 157 with the valve body 113. At this time, the connection portion of the membrane part 155 with the outer peripheral edge part 157 repeatedly slides against the valve body 113 and may generate particles due to abrasion by friction. Since a contact region of the membrane part 155 between the valve body 113 and the membrane part 155 in the vicinity of the outer peripheral edge part 157 faces a fluid-contact region in the valve chamber 119, if particles are generated, such particles will be mixed into the fluid flowing through the needle valve 111. However, in the diaphragm 115, similarly to the diaphragm 15, the connection portion between the membrane part 155 and the outer peripheral edge part 157 is formed of a crosslinked resin material, and the membrane part 155 includes a membrane-part non-crosslinked resin portion formed of a non-crosslinked resin material and a membrane-part crosslinked resin portion formed of the crosslinked resin material. The membrane-part crosslinked resin portion of the membrane part 155 constitutes the portion adjacent to the outer peripheral edge part 157, and the membrane-part non-crosslinked resin portion of the membrane part 155 constitutes a portion on a side closer to the needle 153 than the membrane-part crosslinked resin portion. Accordingly, even when the diaphragm 115 according to the present invention is used in the needle valve 111, the effects of suppressing the generation of particles can be achieved similarly to the diaphragm 15.

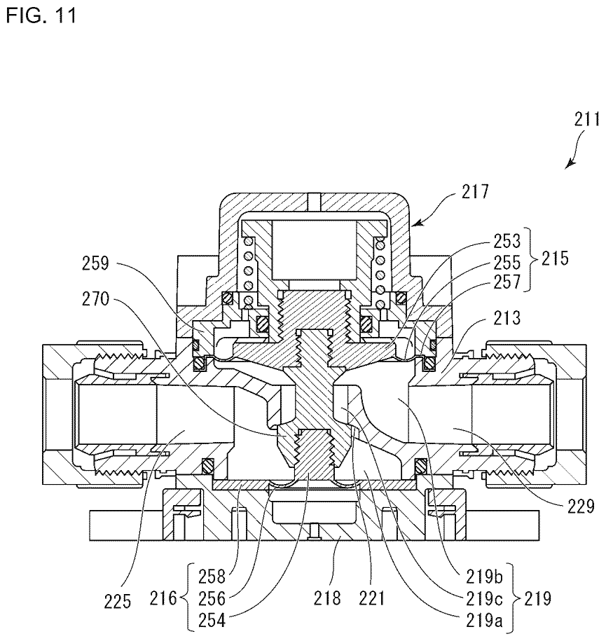

FIG. 11 shows a constant pressure valve 211 that is a third embodiment of a diaphragm valve using a diaphragm 215 according to the present invention. The constant pressure valve 211 includes a valve body 213, a main diaphragm 215, a follower diaphragm 216, a valve element part 270 coupled to the main diaphragm 215 and the follower diaphragm 216, a force-applying mechanism 217 that applies a force to the main diaphragm 215, and a base plate 218. The force-applying mechanism 217 is attached to an upper portion of the valve body 213, and the base plate 218 is attached to a lower portion of the valve body 213. Similar to the diaphragm valve 11, the valve body 213 has a valve chamber 219 formed at a center thereof and opened upward and downward, and an inlet flow passage 225 and an outlet flow passage 229 communicating with the valve chamber 219. The valve chamber 219 includes a first valve chamber 219a that communicates with the inlet flow passage 225 and opens downward, a second valve chamber 219b that communicates with the outlet flow passage 229 and opens upward, and a communication passage 219c that communicates the first valve chamber 219a and the second valve chamber 219b with each other. The first valve chamber 219a is formed, around an opening from the communication passage 219c to the first valve chamber 219a, with an annular valve seat 221, and the valve element part 270 is configured to vertically move in the movement axis direction in conjunction with the main diaphragm 215 to approach and separate from the valve seat 221.

The main diaphragm 215 is arranged so as to close an upper opening of the second valve chamber 219b and is fixed to the valve body 213, and the follower diaphragm 216 is arranged so as to close a lower opening of the first valve chamber 219a and is fixed to the valve body 213. The main diaphragm 215 includes a first base part 253 serving as a valve function part that is located at a center thereof and vertically moves in the movement axis direction, an annular first membrane part 255 that supports the first base part 253 so that the first base part 253 can vertically move, and a first outer peripheral edge part 257 provided on an outer periphery of the first membrane part 255. The follower diaphragm 216 includes a second base part 254 serving as a valve mechanism that is located at a center thereof and vertically moves in the movement axis direction, an annular second membrane part 256 that supports the second base part 254 so that the second base part 254 can vertically move, and a second outer peripheral edge part 258 provided on an outer periphery of the second membrane part 256. In the embodiment shown in FIG. 11, the first outer peripheral edge part 257 of the main diaphragm 215 is indirectly sandwiched between the force-applying mechanism 217 (specifically, a housing thereof) and the valve body 213 via a diaphragm retainer 259. The second outer peripheral edge part 258 of the follower diaphragm 216 has an outermost periphery thereof directly sandwiched between the base plate 218 and the valve body 213. However, the first outer peripheral edge part 257 of the main diaphragm 215 may alternatively be directly sandwiched between the force-applying mechanism 217 (specifically, the housing thereof) and the valve body 213, and the second outer peripheral edge part 258 of the follower diaphragm 216 may alternatively be indirectly sandwiched between the base plate 218 and the valve body 213 via a diaphragm retainer.

The first base part 253 of the main diaphragm 215 is coupled to an upper portion of the valve element part 270, and the second base part 254 of the follower diaphragm 216 is coupled to a lower portion of the valve element part 270. In the embodiment shown in FIG. 11, the force-applying mechanism 217 includes a piston arranged in a mechanism accommodating space inside a housing thereof so as to be vertically movable, the diaphragm retainer 259 that also functions as a spring seat, and a coil spring arranged between the diaphragm retainer 259 and a flange portion provided on the piston, and is configured to apply an upward biasing force to the piston by means of the coil spring. The piston is coupled to the first base part 253 of the main diaphragm 215, and the first base 253 is applied with the upward biasing force by the coil spring of the force-applying mechanism 217. Moreover, a working fluid supply port is provided in an upper portion of the housing of the force-applying mechanism 217 so that a working fluid can be supplied to and discharged from the mechanism accommodating space inside the housing. A recessed portion is formed at the upper center of the base plate 218, and a vent hole is formed in a bottom surface of the recessed portion.

In the constant pressure valve 211 configured as described above, the valve element part 270 is acted upon by an upward force due to a biasing force of the coil spring of the force-applying mechanism 217 and a pressure applied to the lower surface of the main diaphragm 215 by the fluid in the second valve chamber 219b. Further, the valve element part 270 is acted upon by a downward force due to a pressure applied to the upper surface of the main diaphragm 215 by the working fluid in the mechanism accommodating space of the force-applying mechanism 217. Strictly speaking, the lower surface of the valve element part 270 and the upper surface of the second membrane part 256 of the follower diaphragm 216 receive fluid pressure from the fluid in the first valve chamber 219a, but, because these pressure-receiving areas are set to be substantially equal, both forces are substantially canceled out. Accordingly, the valve element part 270 comes to rest at a position where the above-described three forces (i.e., the biasing force of the coil spring, the force due to the pressure applied to the lower surface of the main diaphragm 215 by the fluid in the second valve chamber 219b, and the force due to the pressure applied to the upper surface of the main diaphragm 215 by the working fluid) are balanced. Moreover, when increasing the pressure of the working fluid supplied to the force-applying mechanism 217, a force pushing down the main diaphragm 215 is increased, the valve element part 270 and the valve seat 221 separate from each other, and the pressure in the second valve chamber 219b is increased. Conversely, when decreasing the pressure of the working fluid supplied to the force-applying mechanism 217, a force pushing down the main diaphragm 215 is decreased, the valve element part 270 and the valve seat 221 approach each other, and the pressure in the second valve chamber 219b is decreased. Accordingly, by adjusting the pressure of the working fluid, the pressure in the second valve chamber 219b can be set to a desired value.

When the fluid pressure on the inlet flow passage 225 side is increased in the state where the above-described three forces are balanced, the pressure of the fluid in the second valve chamber 219b is also increased instantaneously, thereby increasing the fluid pressure acting on the lower surface of the first membrane part 255 of the main diaphragm 215. Consequently, the main diaphragm 215 moves upward, and along with this, the valve element part 270 also moves upward. As a result, the valve element part 270 and the valve seat 221 approach each other, the pressure of the fluid in the second valve chamber 219b is decreased, and ultimately the valve element part 270 moves to and comes to rest at the position where the above three forces are balanced. On the other hand, when the fluid pressure on the inlet flow passage 225 side is decreased in the state where the above-described three forces are balanced, the pressure of the fluid in the second valve chamber 219b is also instantaneously decreased, thereby decreasing the fluid pressure acting on the lower surface of the first membrane part 255 of the main diaphragm 215. Consequently, the main diaphragm 215 moves downward, and along with this, the valve element part 270 also moves downward. As a result, the valve element part 270 and the valve seat 221 separate from each other, the pressure of the fluid in the second valve chamber 219b is increased, and ultimately the valve element part 270 moves to and comes to rest at the position where the above three forces are balanced. In this way, the pressure on the secondary side, namely, the pressure on the side of the second valve chamber 219b and the outlet flow passage 229 communicating therewith is maintained substantially constant.

As described above, in the constant pressure valve 211, during the vertical movement of the first base part 253 of the main diaphragm 215 accompanying the vertical movement of the valve element part 270, the first membrane part 255 of the main diaphragm 215 is deformed, and a connection portion of the first membrane part 255 with the first outer peripheral edge part 257, namely, a portion of the first membrane part 255 adjacent to the first outer peripheral edge part 257, is also deformed following the contour of the diaphragm retainer 259 that sandwiches the first outer peripheral edge part 257. At this time, the connection portion of the first membrane part 255 with the first outer peripheral edge part 257 repeatedly slides against the valve body 213 and may generate particles due to abrasion by friction. Since a contact region of the first membrane part 255 between the valve body 213 and the first membrane part 255 in the vicinity of the first outer peripheral edge part 257 faces a fluid-contact region in the second valve chamber 219b, if particles are generated, such particles will be mixed into the fluid flowing through the constant pressure valve 211. However, in the main diaphragm 215, similarly to the diaphragm 15, the connection portion between the first membrane part 255 and the first outer peripheral edge part 257 is formed of a crosslinked resin material, and the first membrane part 255 includes a membrane-part non-crosslinked resin portion formed of a non-crosslinked resin material and a membrane-part crosslinked resin portion formed of the crosslinked resin material. The membrane-part crosslinked resin portion of the first membrane part 255 constitutes the portion adjacent to the first outer peripheral edge part 257, and the membrane-part non-crosslinked resin portion of the first membrane part 255 constitutes a portion on a side closer to the first base part 253, which is the valve function part, than the membrane-part crosslinked resin portion. Accordingly, even when the main diaphragm 215, which is the diaphragm according to the present invention, is used in the constant pressure valve 211, the effects of suppressing the generation of particles can be achieved similarly to the diaphragm 15.

Note that a portion sandwiched between the valve body 213 and the base plate 218 in the second outer peripheral edge part 258 of the follower diaphragm 216 is spaced apart from a connection portion between the second outer peripheral edge part 258 and the second membrane part 256. Therefore, when the second base part 254 of the follower diaphragm 216 vertically moves accompanying the vertical movement of the valve element part 270, the second membrane part 256 of the follower diaphragm 216 is deformed, but particles are not generated in the fluid-contact region because the second membrane part 256 does not contact with the other members in the fluid-contact region. Accordingly, the necessity of applying the present invention to the follower diaphragm 216 is low.

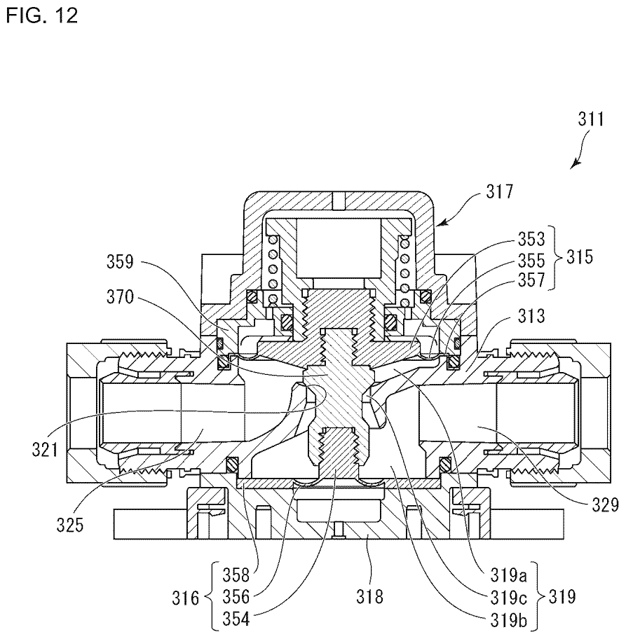

FIG. 12 shows a back pressure valve 311 that is a fourth embodiment of a diaphragm valve using a diaphragm 315 according to the present invention. The back pressure valve 311 includes a valve body 313, the main diaphragm 315, a follower diaphragm 316, a valve element part 370 coupled to the main diaphragm 315 and the follower diaphragm 316, a force-applying mechanism 317 that applies a force to the main diaphragm 315, and a base plate 318. The force-applying mechanism 317 is attached to an upper portion of the valve body 313, and the base plate 318 is attached to a lower portion of the valve body 313. Similar to the diaphragm valve 11, the valve body 313 has a valve chamber 319 formed at a center thereof and opened upward and downward, and has an inlet flow passage 325 and an outlet flow passage 329 communicating with the valve chamber 319. The valve chamber 319 includes a first valve chamber 319a that communicates with the inlet flow passage 325 and opens upward, a second valve chamber 319b that communicates with the outlet flow passage 329 and opens downward, and a communication passage 319c that communicates the first valve chamber 319a and the second valve chamber 319b with each other. The first valve chamber 319a is formed, around an opening from the communication passage 319c to the first valve chamber 319a, with an annular valve seat 321, and the valve element part 370 is configured to vertically move in the movement axis direction in conjunction with the main diaphragm 315 to approach and separate from the valve seat 321.

The main diaphragm 315 is arranged so as to close an upper opening of the first valve chamber 319a and is fixed to the valve body 313, and the follower diaphragm 316 is arranged so as to close a lower opening of the second valve chamber 319b and is fixed to the valve body 313. The main diaphragm 315 includes a first base part 353 serving as a valve function part that is located at a center thereof and vertically moves in the movement axis direction, an annular first membrane part 355 that supports the first base part 353 so that the first base part 353 can vertically move, and a first outer peripheral edge part 357 provided on an outer periphery of the first membrane part 355. The follower diaphragm 316 includes a second base part 354 serving as the valve function part that is located at a center thereof and vertically moves in the movement axis direction, an annular second membrane part 356 that supports the second base part 354 so that the second base part 354 can vertically move, and a second outer peripheral edge part 358 provided on an outer periphery of the second membrane part 356. In the embodiment shown in FIG. 12, the first outer peripheral edge part 357 of the main diaphragm 315 is indirectly sandwiched between the force-applying mechanism 317 (specifically, a housing thereof) and the valve body 313 via a diaphragm retainer 359. The second outer peripheral edge part 358 of the follower diaphragm 316 has an outermost periphery thereof directly sandwiched between the base plate 318 and the valve body 313. However, the first outer peripheral edge part 357 of the main diaphragm 315 may alternatively be directly sandwiched between the force-applying mechanism 317 (specifically, the housing) and the valve body 313, and the second outer peripheral edge part 358 of the follower diaphragm 316 may alternatively be indirectly sandwiched between the base plate 318 and the valve body 313 via a diaphragm retainer.

The first base part 353 of the main diaphragm 315 is coupled to an upper portion of the valve element part 370, and the second base part 354 of the follower diaphragm 316 is coupled to a lower portion of the valve element part 370. In the embodiment shown in FIG. 12, the force-applying mechanism 317 includes a piston arranged in a mechanism accommodating space inside a housing thereof so as to be vertically movable, the diaphragm retainer 359 that also functions as a spring seat, and a coil spring arranged between the diaphragm retainer 359 and a flange portion provided on the piston, and is configured to apply an upward biasing force to the piston by means of the coil spring. The piston is coupled to the first base part 353 of the main diaphragm 315, and the first base part 353 is applied with the upward biasing force by the coil spring of the force-applying mechanism 317. Moreover, a working fluid supply port is provided in an upper portion of the housing of the force-applying mechanism 317 so that a working fluid can be supplied to and discharged from the mechanism accommodating space inside the housing. A recessed portion is formed at the upper center of the base plate 318, and a vent hole is formed in a bottom surface of the recessed portion.

In the back pressure valve 311 configured as described above, the valve element part 370 is acted upon by an upward force due to a biasing force of the coil spring of the force-applying mechanism 317 and a pressure applied to the lower surface of the main diaphragm 315 by the fluid in the first valve chamber 319a. Further, the valve element part 370 is acted upon by a downward force due to a pressure applied to the upper surface of the main diaphragm 315 by the working fluid in the mechanism accommodating space of the force-applying mechanism 317. Strictly speaking, the lower surface of the valve element part 370 and the upper surface of the second membrane part 356 of the follower diaphragm 316 receive fluid pressure from the fluid in the second valve chamber 319b, but, because these pressure-receiving areas are set to be substantially equal, both forces are substantially canceled out. Accordingly, the valve element part 370 comes to rest at a position where the above-described three forces (i.e., the biasing force of the coil spring, the force due to the pressure applied to the lower surface of the main diaphragm 315 by the fluid in the first valve chamber 319a, and the force due to the pressure applied to the upper surface of the main diaphragm 315 by the working fluid) are balanced. Moreover, when increasing the pressure of the working fluid supplied to the force-applying mechanism 317, a force pushing down the main diaphragm 315 is increased, the valve element part 370 and the valve seat 321 approach each other, and the pressure in the first valve chamber 319a is increased. Conversely, when decreasing the pressure of the working fluid supplied to the force-applying mechanism 317, a force pushing down the main diaphragm 315 is decreased, the valve element part 370 and the valve seat 321 separate from each other, and the pressure of the first valve chamber 319a is decreased. Accordingly, by adjusting the pressure in the working fluid, the pressure of the first valve chamber 319a can be set to a desired value.

When the fluid pressure on the inlet flow passage 325 side is increased in the state where the above-described three forces are balanced, the pressure of the fluid in the first valve chamber 319a is increased instantaneously, thereby increasing the fluid pressure acting on the lower surface of the first membrane part 355 of the main diaphragm 315. Consequently, the main diaphragm 315 moves upward, and along with this, the valve element part 370 also moves upward. As a result, the valve element part 370 and the valve seat 321 separate from each other and the pressure of the fluid in the first valve chamber 319a is decreased, and ultimately the valve element part 370 moves to and comes to rest at the position where the above three forces are balanced. On the other hand, when the fluid pressure on the inlet flow passage 325 side is decreased in the state where the above-described three forces are balanced, the pressure of the fluid in the first valve chamber 319a is also instantaneously decreased, thereby decreasing the fluid pressure acting on the lower surface of the first membrane part 355 of the main diaphragm 315. Consequently, the main diaphragm 315 moves downward, and along with this, the valve element part 370 also moves downward. As a result, the valve element part 370 and the valve seat 321 approach each other, the pressure of the fluid in the first valve chamber 319a is increased, and ultimately the valve element part 370 moves to and comes to rest at the position where the above three forces are balanced. In this way, the pressure on the primary side, namely, the pressure on the first valve chamber 319a and the inlet flow passage 325 side communicating therewith is maintained substantially constant.

As described above, in the back pressure valve 311, during the vertical movement of the first base part 353 of the main diaphragm 315 accompanying the vertical movement of the valve element part 370, the first membrane part 355 of the main diaphragm 315 is deformed, and a connection portion of the first membrane part 355 with the first outer peripheral edge part 357, namely, a portion of the first membrane part 355 adjacent to the first outer peripheral edge part 357, is also deformed following the contour of the diaphragm retainer 359 that sandwiches the first outer peripheral edge part 357. At this time, the connection portion of the first membrane part 355 with the first outer peripheral edge part 357 repeatedly slides against the valve body 313 and may generate particles due to abrasion by friction. Since a contact region of the first membrane part 355 between the valve body 313 and the first membrane part 355 in the vicinity of the first outer peripheral edge part 357 faces a fluid-contact region in the first valve chamber 319a, if particles are generated, such particles will be mixed into the fluid flowing through the back pressure valve 311. However, in the main diaphragm 315, similarly to the diaphragm 15, the connection portion between the first membrane part 355 and the first outer peripheral edge part 357 is formed of a crosslinked resin material, and the first membrane part 355 includes a membrane-part non-crosslinked resin portion formed of a non-crosslinked resin material and a membrane-part crosslinked resin portion formed of the crosslinked resin material. The membrane-part crosslinked resin portion of the first membrane part 355 constitutes the portion adjacent to the first outer peripheral edge part 357, and the membrane-part non-crosslinked resin portion of the first membrane part 355 constitutes a portion on a side closer to the first base part 353, which is the valve function part, than the membrane-part crosslinked resin portion. Accordingly, even when the main diaphragm 315, which is the diaphragm according to the present invention, is used in the back pressure valve 311, the effects of suppressing the generation of particles can be achieved similarly to the diaphragm 15.

Note that a portion sandwiched between the valve body 313 and the base plate 318 in the second outer peripheral edge part 358 of the follower diaphragm 316 is spaced apart from a connection portion between the second outer peripheral edge part 358 and the second membrane part 356. Therefore, when the second base part 354 of the follower diaphragm 316 vertically moves accompanying the vertical movement of the valve element part 370, the second membrane part 356 of the follower diaphragm 316 is deformed, but particles are not generated in the fluid-contact region because the second membrane part 356 does not contact with the other members in the fluid-contact region. Accordingly, the necessity of applying the present invention to the follower diaphragm 316 is low.

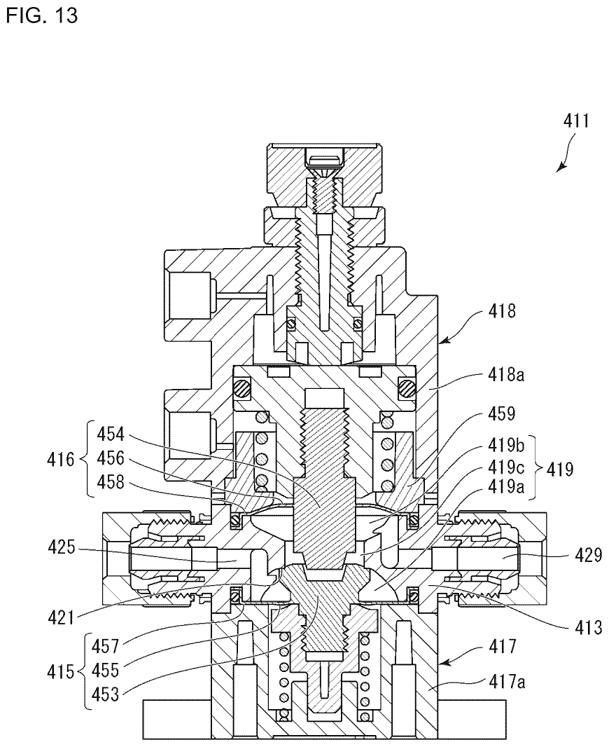

FIG. 13 shows a suck-back valve 411 that is a fifth of a diaphragm valve of using two diaphragms according to the present invention. The suck-back valve 411 includes a valve body 413, a first diaphragm 415, a second diaphragm 416, a first force-applying mechanism 417 that applies a force to the first diaphragm 415, and a second force-applying mechanism 418 that applies a force to the second diaphragm 416. The first force-applying mechanism 417 is attached to a lower portion of the valve body 413, and the second force-applying mechanism 418 is attached to an upper portion of the valve body 413. Similar to the diaphragm valve 11, the valve body 413 has a valve chamber 419 formed at a center thereof and opened upward and downward, and an inlet flow passage 425 and an outlet flow passage 429 communicating with the valve chamber 419. The valve chamber 419 includes a first valve chamber 419a that communicates with the inlet flow passage 425 and opens downward, a second valve chamber 419b that communicates with the outlet flow passage 429 and opens upward, and a communication passage 419c that communicates the first valve chamber 419a and the second valve chamber 419b with each other. The first valve chamber 419a is formed, around an opening from the communication passage 419c to the first valve chamber 419a, with an annular valve seat 421.

The first diaphragm 415 is arranged so as to close a lower opening of the first valve chamber 419a and is fixed to the valve body 413, and the second diaphragm 416 is arranged so as to close an upper opening of the second valve chamber 419b and is fixed to the valve body 413. The first diaphragm 415 includes a valve element part 453 serving as a valve function part that is located at a center thereof and vertically moves in the movement axis direction to be brought into contact with and away from the valve seat 421, an annular first membrane part 455 that supports the valve element part 453 so that the valve element part 453 can vertically move, and a first outer peripheral edge part 457 provided on an outer periphery of the first membrane part 455. The second diaphragm 416 functions as an auxiliary diaphragm that assists the operations of the first diaphragm 415. The second diaphragm 416 includes a pressing part 454 serving as an auxiliary valve function part that is located at a center thereof and vertically moves in the movement axis direction, an annular second membrane part 456 serving as an auxiliary membrane part that supports the pressing part 454 so that the pressing part 454 can vertically move, and a second outer peripheral edge part 458 serving as an auxiliary outer peripheral edge part provided on an outer periphery of the second membrane part 456. In the embodiment shown in FIG. 13, the first outer peripheral edge part 457 of the first diaphragm 415 is directly sandwiched between the first force-applying mechanism 417 (specifically, a housing 417a thereof) and the valve body 413. The second outer peripheral edge part 458 of the second diaphragm 416 is indirectly sandwiched between the second force-applying mechanism 418 (specifically, a housing 418a thereof) and the valve body 413 via a diaphragm retainer 459. However, the first outer peripheral edge part 457 of the first diaphragm 415 may alternatively be indirectly sandwiched between the first force-applying mechanism 417 (specifically, the housing 417a thereof) and the valve body 413 via a diaphragm retainer, and the second outer peripheral edge part 458 of the second diaphragm 416 may alternatively be directly sandwiched between the second force-applying mechanism 418 (specifically, the housing 418a thereof) and the valve body 413.

The pressing part 454 of the second diaphragm 416 is arranged in the valve chamber 419 so as to face the valve element part 453 of the first diaphragm 415 in the movement axis direction, and is configured to be brought into contact with and away from the valve element part 453 by vertically moving in the movement axis direction. When the pressing part 454 is in contact with the valve element part 453 of the first diaphragm 415, the second diaphragm 416 applies a downward force to the valve element part 453 via the pressing part 454.

In the embodiment shown in FIG. 13, the first force-applying mechanism 417 includes a piston arranged in a mechanism accommodating space inside the housing 417a thereof so as to be vertically movable and a coil spring arranged between a flange portion provided on an upper portion of the piston and a bottom portion of the mechanism accommodating space, and is configured to apply an upward biasing force to the piston by means of the coil spring. The piston is coupled to the valve element part 453 of the first diaphragm 415, and the valve element part 453 is applied with the upward biasing force by the coil spring of the first force-applying mechanism 417 in a direction of pressing against the valve seat 421. In the embodiment shown in FIG. 13, the second force-applying mechanism 418 includes a piston arranged in a mechanism accommodating space inside the housing 418a thereof so as to be vertically movable, the diaphragm retainer 459 that also functions as a spring seat, and a coil spring arranged between the diaphragm retainer 459 and a flange portion provided on an upper portion of the piston, and is configured to apply an upward biasing force to the piston by means of the coil spring. The flange portion of the piston has an outer peripheral surface configured to slide on an inner peripheral surface of the housing 418a, thereby partitioning the mechanism accommodating space into an upper space and a lower space, and the piston can be reciprocated by supplying and discharging a working fluid to and from the upper space. The piston has a lower end coupled to the pressing part 454 of the second diaphragm 416, so that the pressing part 454 of the second diaphragm 416 can be vertically moved in accordance with the vertical movement of the piston.

In the suck-back valve 411 configured as described above, the valve element part 453 of the first diaphragm 415 is applied with the upward biasing force by the first force-applying mechanism 417, and the valve element part 453 is pressed against the valve seat 421 by the upward biasing force provided by the first force-applying mechanism 417 to be brought in a closed valve state in a state where the pressing part 454 of the second diaphragm 416 is separated from the valve element part 453. From this state, when the piston is moved downward against the biasing force of the coil spring of the second force-applying mechanism 418 by supplying the working fluid to the upper space of the mechanism accommodating space of the second force-applying mechanism 418, the pressing part 454 coupled to the piston moves down and comes into contact with the valve element part 453. When the piston is moved downward from this state by further supplying the working fluid to the upper space of the mechanism accommodating space and discharging the working fluid from the lower space, the pressing part 454 applies the downward force to the valve element part 453, and the valve element part 453 moves downward against the upward biasing force of the first force-applying mechanism 417 and separates from the valve seat 421 to be brought into an open valve state.

When the working fluid is discharged from the upper space of the mechanism accommodating space of the second force-applying mechanism 418 in the above open valve state, the piston moves upward due to the biasing force of the coil spring, and the pressing part 454 coupled to the piston moves upward and the pressing part 454 separates from the valve element part 453. As a result, the valve element part 453 is pressed against the valve seat 421 by the upward biasing force of the first force-applying mechanism 417 to be brought into the closed valve state. Thereafter, when the working fluid is further discharged from the upper space of the mechanism accommodating space of the second force-applying mechanism 418, the piston moves upward due to the biasing force of the coil spring, and the pressing part 454 coupled to the piston moves upward. As a result, the volume of the second valve chamber 419b is increased, thereby causing a suck-back effect that can prevent dripping from the downstream-side flow passage.

As described above, in the suck-back valve 411, during the vertical movement of the valve element part 453 of the first diaphragm 415, the first membrane part 455 of the first diaphragm 415 is deformed, and a connection portion of the first membrane part 455 with the first outer peripheral edge part 457, namely, a portion of the first membrane part 455 adjacent to the first outer peripheral edge part 457, is also deformed along an outer peripheral surface of the first valve chamber 419a. Likewise, during the vertical movement of the pressing part 454 of the second diaphragm 416, the second membrane part 456 of the second diaphragm 416 is also deformed, and a connection portion of the second membrane part 456 with the second outer peripheral edge part 458, namely, a portion of the second membrane part 456 adjacent to the second outer peripheral edge part 458, is also deformed following the contour of the diaphragm retainer 459. At this time, the connection portion of the first membrane part 455 with the first outer peripheral edge part 457 and the connection portion of the second membrane part 456 with the second outer peripheral edge part 458 repeatedly slide against the valve body 413 and may generate particles due to abrasion by friction. If particles are generated, the particles will be mixed into the fluid flowing through the suck-back valve 411. However, in the first diaphragm 415, similarly to the diaphragm 15, the connection portion between the first membrane part 455 and the first outer peripheral edge part 457 is formed of a crosslinked resin material, and the first membrane part 455 includes a membrane-part non-crosslinked resin portion formed of a non-crosslinked resin material and a membrane-part crosslinked resin portion formed of the crosslinked resin material. The membrane-part crosslinked resin portion of the first membrane part 455 constitutes the portion of the first membrane part 455 adjacent to the first outer peripheral edge part 457, and the membrane-part non-crosslinked resin portion of the first membrane part 455 constitutes a portion of the first membrane part 455 on a side closer to the valve element part 453, which is the valve function part, than the membrane-part crosslinked resin portion. Further, in the second diaphragm 416, similarly to the diaphragm 15, the connection portion between the second membrane part 456 and the second outer peripheral edge part 458 is formed of the crosslinked resin material, and the second membrane part 456 includes a membrane-part non-crosslinked resin portion formed of the non-crosslinked resin material and a membrane-part crosslinked resin portion formed of the crosslinked resin material. The membrane-part crosslinked resin portion of the second membrane part 456 constitutes the portion of the second membrane 456 adjacent to the second outer peripheral edge part 458, and the membrane-part non-crosslinked resin portion of the second membrane part 456 constitutes a portion of the second membrane part 456 on a side closer to the pressing part 454, which is the valve function part, than the membrane-part crosslinked resin portion. Accordingly, even when the first diaphragm 415 and the second diaphragm 416, which are the diaphragms according to the present invention, are used in the suck-back valve 411, the effects of suppressing the generation of particles can be achieved similarly to the diaphragm 15.

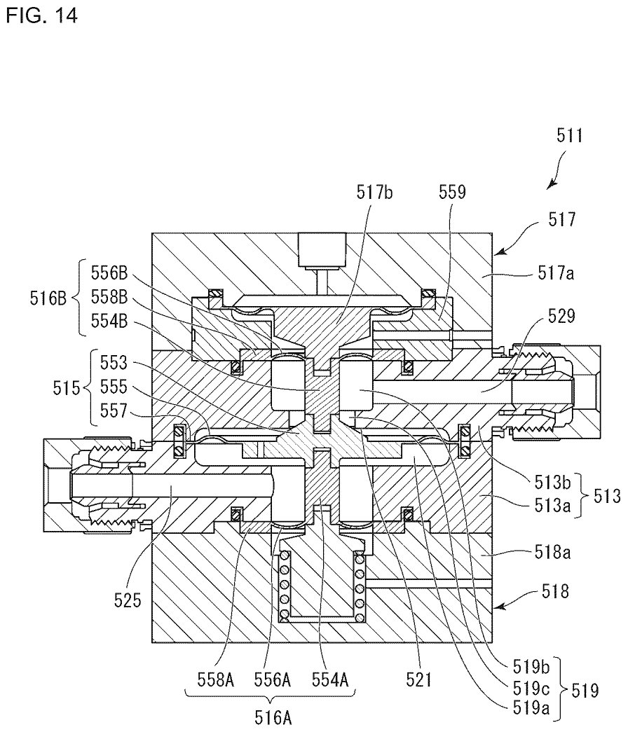

FIG. 14 shows a constant flow valve 511 that is a sixth embodiment of a diaphragm valve using three diaphragms according to the present invention. The constant flow valve 511 includes a valve body 513, a first diaphragm 515, a second diaphragm 516A, a third diaphragm 516B, a first force-applying mechanism 517 that applies a force to the third diaphragm 516B, and a second force-applying mechanism 518 that applies a force to the second diaphragm 516A. The first force-applying mechanism 517 is attached to an upper portion of the valve body 513, and the second force-applying mechanism 518 is attached to a lower portion of the valve body 513. Similar to the diaphragm valve 11, the valve body 513 has a valve chamber 519 formed at a center thereof and opened upward and downward, and an inlet flow passage 525 and an outlet flow passage 529 communicating with the valve chamber 519. The valve chamber 519 includes a first valve chamber 519a that communicates with the inlet flow passage 525, a second valve chamber 519b that communicates with the outlet flow passage 529, and a communication passage 519c that communicates the first valve chamber 519a and the second valve chamber 519b with each other. The first valve chamber 519a is formed, around an opening from the communication passage 519c to the first valve chamber 519a, with an annular valve seat 521.

The valve body 513 is constructed by connecting a first valve body 513a and a second valve body 513b. The inlet flow passage 525 is formed in the first valve body 513a, and the communication passage 519c, the second valve chamber 519b, and the outlet flow passage 529 are formed in the second valve body 513b. The first valve chamber 519a is formed across both the first valve body 513a and the second valve body 513b. In other words, the first valve chamber 519a is formed in a divided manner in the first valve body 513a and the second valve body 513b.

The first diaphragm 515 includes a valve element part 553 serving as a valve function part that is located at a center thereof and vertically moves in the movement axis direction to be brought into contact with and away from the valve seat 521, an annular first membrane part 555 that supports the valve element part 553 so that the valve element part 553 can vertically move, and a first outer peripheral edge part 557 provided on an outer periphery of the first membrane part 555, and the valve element part 553 is formed with a through-hole extending therethrough in the vertical direction. The second diaphragm 516A includes a first base part 554A serving as the valve function part that is located at a center thereof and vertically moves in the movement axis direction, an annular second membrane part 556A that supports the first base part 554A so as to be vertically movable, and a second outer peripheral edge part 558A provided on an outer periphery of the second membrane part 556A. The third diaphragm 516B includes a second base part 554B serving as the valve function part that is located at a center thereof and vertically moves in the movement axis direction, an annular third membrane part 556B that supports the second base 554B so as to be vertically movable, and a third outer peripheral edge part 558B provided on an outer periphery of the third membrane part 556B.

In the embodiment shown in FIG. 14, the first outer peripheral edge part 557 of the first diaphragm 515 is directly sandwiched between the first valve body 513a and the second valve body 513b. In other words, the first diaphragm 515 is supported by the valve body 513 so as to partition the first valve chamber 519a into two spaces, and the two partitioned spaces of the first valve chamber 519a communicate with each other via the through-hole provided in the valve element part 553. The third outer peripheral edge part 558B of the third diaphragm 516B is indirectly sandwiched between the first force-applying mechanism 517 (specifically, a housing 517a thereof) and the valve body 513 via a diaphragm retainer 559. The second outer peripheral edge part 558A of the second diaphragm 516A is directly sandwiched between the second force-applying mechanism 518 (specifically, a housing 518a thereof) and the valve body 513.

However, the second outer peripheral edge part 558A of the second diaphragm 516A may be indirectly sandwiched between the second force-applying mechanism 518 (specifically, the housing 518a thereof) and the valve body 513 via a diaphragm retainer, and the third outer peripheral edge part 558B of the third diaphragm 516B may be directly sandwiched between the first force-applying mechanism 517 (specifically, the housing 517a) and the valve body 513.

The second base part 554B of the third diaphragm 516B is coupled to an upper portion of the valve element part 553 of the first diaphragm 515, and the first base part 554A of the second diaphragm 516A is coupled to a lower portion of the valve element part 553.

In the embodiment shown in FIG. 14, the first force-applying mechanism 517 functions as a drive unit for the valve element part 553 of the first diaphragm 515, and includes the housing 517a formed with a mechanism accommodating space therein and a drive diaphragm 517b which has an outer peripheral edge part sandwiched between the diaphragm retainer 559 and the housing 517a of the first force-applying mechanism 517 to be supported within the mechanism accommodating space, with a drive base part at a central portion of the drive diaphragm 517b coupled to the second base part 554B of the third diaphragm 516B. The first force-applying mechanism 517 is partitioned by the drive diaphragm 517b into an upper space and a lower space, and the drive base part can be vertically moved by supplying and discharging a working fluid to and from the upper space. Since the drive base part of the first force-applying mechanism 517 is coupled to the second base part 554B of the third diaphragm 516B and the second base part 554B is coupled to the valve element part 553 of the first diaphragm 515, the first force-applying mechanism 517 can apply a force to the valve element part 553 of the first diaphragm 515 via the third diaphragm 516B to drive the valve element part 553. In other words, the valve element part 553 can be driven by the first force-applying mechanism 517 via the third diaphragm 516B. In the embodiment shown in FIG. 14, the second force-applying mechanism 518 includes a piston arranged in a mechanism accommodating space inside the second force-applying mechanism 518 so as to be vertically movable and a coil spring arranged between a flange portion provided on an upper portion of the piston and a bottom portion of the mechanism accommodating space, and is configured to apply an upward biasing force to the piston by means of the coil spring. The piston is coupled to the first base part 554A of the second diaphragm 516A, and the first base 554A is applied with the upward biasing force by the coil spring of the second force-applying mechanism 518. Since the first base part 554A is coupled to the valve element part 553 of the first diaphragm 515, the second force-applying mechanism 518 can exert the biasing force on the valve element part 553 of the first diaphragm 515 via the second diaphragm 516A. In other words, the valve element part 553 is acted upon by the upward biasing force in a direction to be pressed against the valve seat 521 by the second force-applying mechanism 518 via the second diaphragm 516A.

In the constant flow valve 511 configured as described above, the valve element part 553 of the first diaphragm 515 is applied with the upward biasing force by the second force-applying mechanism 518 via the second diaphragm 516A, and in a state where no force is applied by the first force-applying mechanism 517, the valve element part 553 is pressed against the valve seat 521 by the above upward force, thereby being brought into a closed valve state. From this state, when the drive diaphragm is moved downward by supplying the working fluid to the upper space of the mechanism accommodating space of the first force-applying mechanism 517, the second base part 554B of the third diaphragm 516B coupled to the drive base part of the drive diaphragm moves downward. Consequently, the valve element part 553 of the first diaphragm 515 coupled to the second base part 554B moves downward against the biasing force by the second force-applying mechanism 518. As a result, the valve element part 553 separates from the valve seat 521 to be brought into an open valve state, and thus the fluid flows from the inlet flow passage 525 to the outlet flow passage 529.

Conversely, from the open valve state, when the drive diaphragm is moved upward by discharging the working fluid from the upper space of the mechanism accommodating space of the first force-applying mechanism 517, the second base part 554B of the third diaphragm 516B coupled to the drive base of the drive diaphragm moves upward. Consequently, the valve element part 553 of the first diaphragm 515 coupled to the second base part 554B moves upward due to the biasing force of the second force-applying mechanism 518 and comes into contact with the valve seat 21 to be brought into the closed valve state.

When the pressure of the fluid in a lower-side space of the first valve chamber 519a increases in the open valve state, the pressure of the fluid acting on the lower surface of the first diaphragm 515 also increases, whereby the upward force acting on the first diaphragm 515 increases. As a result, the valve element part 553 is moved upward, and thus an opening area between the valve seat 521 and the valve element part 553 is decreased. Then, the pressure of the fluid in an upper-side space of the first valve chamber 519a above the first diaphragm 515 increases, and the valve element part 553 comes to rest at an equilibrium position where the pressure of the fluid in the upper-side space and the pressure of the fluid in the lower-side space in the first valve chamber 519a become equal. Moreover, when the pressure of the fluid in the upper-side space of the first valve chamber 519a increases in the open valve state, the pressure of the fluid acting on the upper surface of the first diaphragm 515 also increases, whereby the downward force acting on the first diaphragm 515 increases. As a result, the valve element part 553 is moved downward, and thus the opening area between the valve seat 521 and the valve element part 553 is increased. Then, the pressure of the fluid in the upper-side space of the first valve chamber 519a above the first diaphragm 515 decreases, and the valve element part 553 comes to rest at an equilibrium position where the pressure of the fluid in the upper-side space and the pressure of the fluid in the lower-side space in the first valve chamber 519a become equal. Since the biasing force provided by the second force-applying mechanism 518 is constant, the pressure of the fluid in the upper-side space and the pressure of the fluid in the lower-side space in the first valve chamber 519a can be changed to control a flow rate by adjusting the pressure of the working fluid of the first force-applying mechanism 517.

As described above, in the constant flow valve 511, during the vertical movement of the valve element part 553 of the first diaphragm 515, the first membrane part 555 of the first diaphragm 515 is deformed, and a connection portion of the first membrane part 555 with the first outer peripheral edge part 557, namely, a portion of the first membrane part 555 adjacent to the first outer peripheral edge part 557, is also deformed along an outer peripheral surface of the first valve chamber 519a. Likewise, during the vertical movement of the first base part 554A of the second diaphragm 516A and the second base part 554B of the third diaphragm 516B, the second membrane part 556A of the second diaphragm 516A and the third membrane part 556B of the third diaphragm 516B are also deformed, a connection portion of the second membrane part 556A with the second outer peripheral edge part 558A (specifically, a portion of the second membrane part 556A adjacent to the second outer peripheral edge part 558A) is also deformed following the contour of an inner peripheral wall of the first valve chamber 519a, and a connection portion of the third membrane part 556B with the third outer peripheral edge part 558B (i.e., a portion of the third membrane part 556B adjacent to the third outer peripheral edge part 558B) is also deformed following the contour of an inner peripheral wall of the second valve chamber 519b. At this time, the connection portion of the first membrane part 555 with the first outer peripheral edge part 557, the connection portion of the second membrane part 556A with the second outer peripheral edge part 558A, and the connection portion of the third membrane part 556B with the third outer peripheral edge part 558B repeatedly slide against the valve body 513 and may generate particles due to abrasion by friction. If particles are generated, the particles will be mixed into the fluid flowing through the constant flow valve 511. However, in the first diaphragm 515, similarly to the diaphragm 15, the connection portion between the first membrane part 555 and the first outer peripheral edge part 557 is formed of a crosslinked resin material, and the first membrane part 555 includes a membrane-part non-crosslinked resin portion formed of a non-crosslinked resin material and a membrane-part crosslinked resin portion formed of the crosslinked resin material. The membrane-part crosslinked resin portion of the first membrane part 555 constitutes the portion of the first membrane part 555 adjacent to the first outer peripheral edge part 557, and the membrane-part non-crosslinked resin portion of the first membrane part 555 constitutes a portion of the first membrane part 555 on a side closer to the valve element part 553, which is the valve function part, than the membrane-part crosslinked resin portion. Likewise, in the second diaphragm 516A, similarly to the diaphragm 15, the connection portion between the second membrane part 556A and the second outer peripheral edge part 558A is formed of the crosslinked resin material, and the second membrane part 556A includes a membrane-part non-crosslinked resin portion formed of the non-crosslinked resin material and a membrane-part crosslinked resin portion formed of the crosslinked resin material. The membrane-part crosslinked resin portion of the second membrane part 556A constitutes the portion of the second membrane part 556A adjacent to the second outer peripheral edge part 558A, and the membrane-part non-crosslinked resin portion of the second membrane part 556A constitutes a portion of the second membrane part 556A on a side closer to the first base part 554A., which is the valve function part, than the membrane-part crosslinked resin portion. Further, in the third diaphragm 516B, similarly to the diaphragm 15, the connection portion between the third membrane part 556B and the third outer peripheral edge part 558B is formed of the crosslinked resin material, and the third membrane part 556B includes a membrane-part non-crosslinked resin portion formed of the non-crosslinked resin material and a membrane-part crosslinked resin portion formed of the crosslinked resin material. The membrane-part crosslinked resin portion of the third membrane part 556B constitutes the portion of the third membrane part 556B adjacent to the third outer peripheral edge part 558B, and the membrane-part non-crosslinked resin portion of the third membrane part 556B constitutes a portion of the third membrane part 556B on a side closer to the second base part 554B, which is the valve function part, than the membrane-part crosslinked resin portion. Accordingly, even when the first diaphragm 515, the second diaphragm 516A, and the third diaphragm 516B, which are the diaphragms according to the present invention, are used in the constant flow valve 511, the effects of suppressing particle generation can be provided similarly to the diaphragm 15.

While the diaphragms 15, 115, 215, 315, 415, 416, 515, 516A, and 516B according to the present invention and the diaphragm valves 11, 111, 211, 311, 411, and 511 including them have been described above with reference to the shown embodiments, the present invention is not limited to the shown embodiments. For example, in the needle valve 111 that is the second embodiment of the diaphragm valve, the constant pressure valve 211 that is the third embodiment of the diaphragm valve, the back pressure valve 311 that is the fourth embodiment of the diaphragm valve, the suck-back valve 411 that is the fifth embodiment of the diaphragm valve, and the constant flow valve 511 that is the sixth embodiment of the diaphragm valve, the bottom portion of the valve element part and the valve seat portion thereof have not been specifically described. However, similarly to the first embodiment of the diaphragm valve 11, the bottom portion of the valve element part and the valve seat portion may be constituted by the crosslinked resin portion formed of the crosslinked resin material. In this case as well, it is possible to further enhance the effects of suppressing particle generation. In the shown embodiments, only the connection portion of the membrane part of the diaphragm adjacent to the outer peripheral edge part is constituted by the crosslinked resin portion. However, as long as the membrane part can ensure enough flexibility to follow the reciprocating movement of the valve element part, portions other than the connection portion of the membrane part may also be constituted by crosslinked resin portions. Moreover, in the shown embodiments, it has been described that the diaphragm is formed of a single resin material such as PTFE. However, the diaphragm may be formed of different resin materials, for example, by forming a bottom surface portion of the valve element part or the like from PFA. Even in this case, the different resin materials can be crosslinked respectively by irradiation of radiation or the like to constitute crosslinked resin portions.

### DESCRIPTION OF REFERENCE NUMERALS

11 diaphragm valve
13 valve body
15 diaphragm
17 drive unit
19 valve chamber
21 valve seat
25 inlet flow passage
29 outlet flow passage
53 valve element part
55 membrane part
57 outer peripheral edge part
59 diaphragm retainer
61 connection portion
63 bottom surface portion
65 groove portion
67 valve seat portion
111 needle valve
113 valve body
115 diaphragm
117 drive unit
119 valve chamber
121 valve seat
125 inlet flow passage
129 outlet flow passage
153 needle
155 membrane part
157 outer peripheral edge part
159 diaphragm retainer
211 constant pressure valve
213 valve body
215 main diaphragm
216 follower diaphragm
217 force-applying mechanism
219 valve chamber
219a first valve chamber
219b second valve chamber
219c communication passage
221 valve seat
225 inlet flow passage
229 outlet flow passage
253 first base part
254 second base part
255 first membrane part
256 second membrane part
257 first outer peripheral edge part
258 second outer peripheral edge part
259 diaphragm retainer
270 valve element part
311 back pressure valve
313 valve body
315 main diaphragm
316 follower diaphragm
317 force-applying mechanism
319 valve chamber
319a first valve chamber
319b second valve chamber
319c communication passage
321 valve seat
325 inlet flow passage
329 outlet flow passage
353 first base part
354 second base part
355 first membrane part
356 second membrane part
357 first outer peripheral edge part
358 second outer peripheral edge part
359 diaphragm retainer
370 valve element part
411 suck-back valve
413 valve body
415 first diaphragm
416 second diaphragm
417 first force-applying mechanism
418 second force-applying mechanism
419 valve chamber
419a first valve chamber
419b second valve chamber
419c communication passage
421 valve seat
425 inlet flow passage
429 outlet flow passage
453 valve element part
454 pressing part
455 first membrane part
456 second membrane part
457 first outer peripheral edge part
458 second outer peripheral edge part
459 diaphragm retainer
511 constant flow valve
513 valve body
513a first valve body
513b second valve body
515 first diaphragm
516A second diaphragm
516B third diaphragm
517 first force-applying mechanism
518 second force-applying mechanism
519 valve chamber
519a first valve chamber
519b second valve chamber
519c communication passage
521 valve seat
525 inlet flow passage
529 outlet flow passage
553 valve element part
554A first base part
554B second base part
555 first membrane part
556A second membrane part
556B third membrane part
557 first outer peripheral edge part
558A second outer peripheral edge part
558B third outer peripheral edge part
559 diaphragm retainer

1. A diaphragm comprising a valve function part provided at a center thereof, an annular membrane part extending outwardly from the valve function part and being deformable in a direction of a movement axis, and an outer peripheral edge part connected to an outer edge of the membrane part and sandwiched between two members, said valve function part being movably supported by the membrane part in the direction of the movement axis,
wherein the diaphragm is formed of a resin material, and the membrane part includes a membrane-part non-crosslinked resin portion formed of a non-crosslinked resin material and a membrane-part crosslinked resin portion formed of a crosslinked resin material obtained by crosslinking the non-crosslinked resin material, said membrane-part crosslinked resin portion constituting a portion of the membrane part adjacent to the outer peripheral edge part, said membrane-part non-crosslinked resin portion constituting a portion of the membrane part on a side closer to the valve function part than the membrane-part crosslinked resin portion.

2. The diaphragm according to claim 1, wherein at least a portion of the outer peripheral edge part of the diaphragm is constituted by an outer-peripheral-edge crosslinked resin portion formed of the crosslinked resin material.

3. The diaphragm according to claim 2, wherein the outer peripheral edge part has a raised sealing portion provided thereon for sealing between the two members, and the sealing portion is constituted by the outer-peripheral-edge crosslinked resin portion.

4. The diaphragm according to claim 1, wherein the valve function part is a valve element part.

5. The diaphragm according to claim 4, wherein the valve element part has a bottom surface portion thereof constituted by a valve-function-part crosslinked resin portion formed of the crosslinked resin material.

6. The diaphragm according to claim 5, wherein the membrane-part crosslinked resin portion is provided outside a maximum outer peripheral surface of the valve element part when viewed in the direction of the movement axis.

7. The diaphragm according to claim 1, wherein the crosslinked resin material is formed by irradiating the non-crosslinked resin material with radiation.

8. A diaphragm valve comprising: a valve body in which a first flow passage, a second flow passage, and a valve chamber communicating with the first and second flow passages are formed; the diaphragm according to claim 1; and a force-applying mechanism for applying a force to the diaphragm, wherein the valve function part is supported by the membrane part so as to be movable along the direction of the movement axis.

9. The diaphragm valve according to claim 8, wherein the outer peripheral edge part is sandwiched between the valve body and the force-applying mechanism.

10. The diaphragm valve according to claim 9, wherein the outer peripheral edge part is sandwiched between the force-applying mechanism and the valve body via a diaphragm retainer.

11. The diaphragm valve according to claim 8, wherein the valve body is configured by connecting a first valve body and a second valve body to each other, and the outer peripheral edge part of the diaphragm is sandwiched between the first valve body and the second valve body.

12. The diaphragm valve according to claim 8, wherein the valve function part is a valve element part that is brought into contact with and away from an annular valve seat portion formed around an opening from the first flow passage to the valve chamber.

13. The diaphragm valve according to claim 8, wherein the valve chamber includes a first valve chamber communicating with the first flow passage, a second valve chamber communicating with the second flow passage, and a communication passage communicating the first valve chamber and the second valve chamber with each other, and there is an annular valve seat portion formed around one end opening of the communication passage, said valve function part being a valve element part that is brought into contact with and away from the valve seat portion or a base part connected to the valve element part that is brought into contact with and away from the valve seat portion.

14. The diaphragm valve according to claim 12, wherein the crosslinked resin material forming the membrane-part crosslinked resin portion of the diaphragm is crosslinked polytetrafluoroethylene or crosslinked perfluoroalkoxyalkane, and the non-crosslinked resin material forming the membrane-part non-crosslinked resin portion of the diaphragm is non-crosslinked polytetrafluoroethylene or non-crosslinked perfluoroalkoxyalkane.

15. The diaphragm valve according to claim 14, wherein the valve seat portion is constituted by a crosslinked resin portion formed of crosslinked polytetrafluoroethylene or crosslinked perfluoroalkoxyalkane.

16. The diaphragm valve according to claim 15, wherein a remaining portion of the valve body other than the valve seat portion is constituted by a non-crosslinked resin portion formed of non-crosslinked polytetrafluoroethylene or non-crosslinked perfluoroalkoxyalkane.

17. The diaphragm valve according to claim 13, wherein the crosslinked resin material forming the membrane-part crosslinked resin portion of the diaphragm is crosslinked polytetrafluoroethylene or crosslinked perfluoroalkoxyalkane, and the non-crosslinked resin material forming the membrane-part non-crosslinked resin portion of the diaphragm is non-crosslinked polytetrafluoroethylene or non-crosslinked perfluoroalkoxyalkane.

18. The diaphragm valve according to claim 17, wherein the valve seat portion is constituted by a crosslinked resin portion formed of crosslinked polytetrafluoroethylene or crosslinked perfluoroalkoxyalkane.

19. The diaphragm valve according to claim 18, wherein a remaining portion of the valve body other than the valve seat portion is constituted by a non-crosslinked resin portion formed of non-crosslinked polytetrafluoroethylene or non-crosslinked perfluoroalkoxyalkane.

20. The diaphragm valve according to claim 8, wherein the crosslinked resin material is formed by irradiating the non-crosslinked resin material with radiation.

21. The diaphragm valve according to claim 13, wherein the diaphragm valve further comprises an auxiliary diaphragm formed of a resin material, and the auxiliary diaphragm includes an auxiliary valve function part provided at a center thereof, an annular auxiliary membrane part extending outwardly from the auxiliary valve function part and being deformable in the direction of the movement axis, and an auxiliary outer peripheral edge part connected to an outer edge of the auxiliary membrane part and sandwiched between two members, said auxiliary valve function part being movably supported by the auxiliary membrane part in the direction of the movement axis and being connected to the valve function part of the diaphragm, said force-applying mechanism applying a force to the valve function part of the diaphragm via the auxiliary valve function part.

22. The diaphragm valve according to claim 21, wherein the auxiliary membrane part includes an auxiliary-membrane-part non-crosslinked resin portion formed of the non-crosslinked resin material and an auxiliary-membrane-part crosslinked resin portion formed of the crosslinked resin material obtained by crosslinking the non-crosslinked resin material, said auxiliary-membrane-part crosslinked resin portion constituting a portion of the auxiliary membrane part adjacent to the auxiliary outer peripheral edge part, said auxiliary-membrane-part non-crosslinked resin portion constituting a portion of the auxiliary membrane part on a side closer to the auxiliary valve function part than the auxiliary-membrane-part crosslinked resin portion.

23. The diaphragm valve according to claim 13, wherein the diaphragm valve further comprises an auxiliary diaphragm formed of a resin material and an auxiliary force-applying mechanism for applying a force to the auxiliary diaphragm, and the auxiliary diaphragm includes an auxiliary valve function part provided at a center thereof, an annular auxiliary membrane part extending outwardly from the auxiliary valve function part and being deformable in the direction of the movement axis, and an auxiliary outer peripheral edge part connected to an outer edge of the auxiliary membrane part and sandwiched between two members, said auxiliary valve function part being movably supported by the auxiliary membrane part in the direction of the movement axis and being applied with a force by the auxiliary force-applying mechanism.

24. The diaphragm valve according to claim 23, wherein the auxiliary valve function part of the auxiliary diaphragm is configured to be able to come into and out of contact with the valve function part of the diaphragm to apply a force to the valve function part.

25. The diaphragm valve according to claim 23, wherein the auxiliary membrane part includes an auxiliary-membrane-part non-crosslinked resin portion formed of the non-crosslinked resin material and an auxiliary-membrane-part crosslinked resin portion formed of the crosslinked resin material obtained by crosslinking the non-crosslinked resin material, said auxiliary-membrane-part crosslinked resin portion constituting a portion of the auxiliary membrane part adjacent to the auxiliary outer peripheral edge part, said auxiliary-membrane-part non-crosslinked resin portion constitutes a portion of the auxiliary membrane part on a side closer to the auxiliary valve function part than the auxiliary-membrane-part crosslinked resin portion.

26. The diaphragm valve according to claim 24, wherein the auxiliary membrane part includes an auxiliary-membrane-part non-crosslinked resin portion formed of the non-crosslinked resin material and an auxiliary-membrane-part crosslinked resin portion formed of the crosslinked resin material obtained by crosslinking the non-crosslinked resin material, said auxiliary-membrane-part crosslinked resin portion constituting a portion of the auxiliary membrane part adjacent to the auxiliary outer peripheral edge part, said auxiliary-membrane-part non-crosslinked resin portion constituting a portion of the auxiliary membrane part on a side closer to the auxiliary valve function part than the auxiliary-membrane-part crosslinked resin portion.
